(19) United States
(12) Patent Application Publication
(10) Pub. No.: US 2012/0172467 A1
(43) Pub. Date: Jul. 5, 2012

(54) FLAME RETARDANT SYSTEM

(75) Inventors: Ingo Bellin, Mannheim (DE); Patrick Spies, Neustadt (DE); Sabine Fuchs, Mannheim (DE); Christoph Fleckenstein, Freigericht (DE); Peter Deglmann, Mannheim (DE); Maximilian Hofmann, Mannheim (DE); Rainer Ostermann, Ludwigshafen (DE); Klaus Hahn, Kirchheim (DE); Hartmut Denecke, Ludwigshafen (DE); Klemens Massonne, Bad Durkheim (DE); Geert Janssens, Nieuwkerken-Waas (BE); Manfred Döring, Worth (DE); Ciesielski Michael, Merseburg (DE); Jochen Wagner, Mutterstadt (DE)

(73) Assignee: BASF SE, Ludwigshafen (DE)

(21) Appl. No.: 13/336,677

(22) Filed: Dec. 23, 2011

Related U.S. Application Data
(60) Provisional application No. 61/427,214, filed on Dec. 27, 2010.

(30) Foreign Application Priority Data
Nov. 2, 2011 (EP) 11 187 484.8

(51) Int. Cl. C08K 5/5398; C08L 81/04; C08L 85/02; C08J 9/06; C08L 25/06; C08J 9/20; C08J 9/228; C08K 5/521; C08J 9/04

(52) U.S. Cl. 521/81; 524/122; 524/109; 524/141; 525/534; 525/535; 521/107; 521/108; 525/150; 525/188; 264/54

(57) ABSTRACT

The invention relates to a flame retardant comprising
a) at least one sulfur compound of the formula (I)

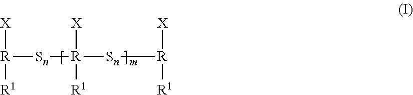

b) at least one halogen-free organophosphorus compound with phosphorus content in the range from 0.5 to 40% by weight, based on the phosphorus compound.

The invention relates to a flame retardant system comprising a phosphorus compound and a sulfur compound, to a polymer composition, in particular in the form of foam, comprising the flame retardant, to processes for producing the polymer composition, and to the use of the foamed polymer composition as insulation material.

The provision of flame retardants to polymers, in particular to foams, is important in a wide variety of applications, for example for molded polystyrene foams made of expandable polystyrene (EPS), or extruded polystyrene foam sheets (XPS) for insulating buildings.

The materials currently mainly used as flame retardants in plastics are polyhalogenated hydrocarbons, optionally in combination with suitable synergists, for example organic peroxides or nitrogen-containing compounds. A typical representative of said traditional flame retardants is hexabromocyclododecane (HBCD), which is used by way of example in polystyrene. Bioaccumulation, and also the persistence of some polyhalogenated hydrocarbons, have led to major attempts to replace halogenated flame retardants within the plastics industry.

DE-A 16 94 945 has proposed combinations of sulfur with bromine compounds and with phosphorus compounds as flame retardant systems for polystyrene foams.

EP-A 0 806 451 also discloses dialkyl polysulfides as synergists alongside elemental sulfur for organophosphorus flame retardants for use in expandable polystyrene foams (EPS) and in extruded polystyrene foams (XPS).

WO 2009/035881 describes phosphorus-sulfur compounds which optionally have di- or polysulfide groups.

Although the known systems themselves achieve good results, there is nevertheless much scope for improvements, particularly with respect to production and to performance characteristics, and to interactions between various additions in the materials requiring protection. By way of example, therefore, increased amounts of the conventional flame retardant HBCD have to be used when athermanous substances such as chalk or graphite are also present.

It is therefore an object to provide further flame retardant systems which provide improvements at least in some sectors, or which reduce the disadvantages of the known systems.

It has been found that flame retardant systems which comprise an oligo- or polysulfide as flame retardant synergist alongside an organophosphorus compound as flame retardant have excellent properties particularly when used in polymer foams. Some compounds of this type are known from U.S. Pat. No. 3,968,062, U.S. Pat. No. 4,873,290, and US 2010/0249278A1 as vulcanizing aids. From said specifications it is not possible to derive any suitability as flame retardant synergists.

The invention therefore provides a flame retardant system comprising

a) at least one sulfur compound of the formula (I),

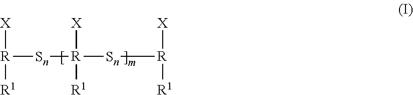

where the definitions of the symbols and indices are as follows:
R, being identical or different, preferably identical, is C₆-C₁₂-aryl, a 5-10-membered heteroaryl group which comprises one or more heteroatoms from the group of N, O, and S, C₁-C₁₈-alkyl, C₂-C₁₈-alkenyl, C₂-C₁₈-alkynyl, or C₃-C₁₀-cycloalkyl;
X, being identical or different, preferably identical, is OR², SR², NR²R³, COOR², CONR², SO₂R², F, Cl, Br, R, H, or a —Y¹—P(Y²)ₚR′R″ group;
Y¹ is O, S, or NR′″;
Y² is O or S;
p is 0 or 1;
R′ and R″, being identical or different, preferably identical, are C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, a heteroaryl group or heteroaryloxy group which comprises one or more heteroatoms from the group of N, O, and S, O—(C₁-C₁₈)-alkyl, O—(C₂-C₁₈)-alkenyl, O—(C₂-C₁₀)-alkynyl, O—(C₆-C₁₂)-aryl, O—(C₃-C₁₀)-cycloalkyl or (C₆-C₁₂)-aryl-(C₁-C₁₈)-alkyl-O;
R′″ is H, C₁-C₁₈-alkyl, or (P(Y²)ₚR′R″);
R¹ being identical or different, preferably identical, is C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, a heteroaryl group which comprises one or more heteroatoms from the group of N, O, and S, O—(C₁-C₁₈)-alkyl, O—(C₂-C₁₈)-alkenyl, O—(C₂-C₁₈)-alkynyl, O—(C₆-C₁₂)-aryl, O—(C₃-C₁₀)-cycloalkyl, (C₆-C₁₂)-aryl-(C₁-C₁₈)-alkyl-O, S—(C₁-C₁₈)-alkyl, S—(C₁-C₁₈)-alkenyl, S—(C₂-C₁₈)-alkynyl, S—(C₆-C₁₂)-aryl, S—(C₃-C₁₀)-cycloalkyl, (C₆-C₁₂)-aryl-(C₁-C₁₈)-alkyl-S, OH, F, Cl, Br, or H;
R² and R³, being identical or different, preferably identical, are H, C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, or a heteroaryl group which comprises one or more heteroatoms from the group of N, O, and S;
n is an integer from 1 to 8, and
m is a number from 1 to 1000;
b) at least one halogen-free organophosphorus compound with phosphorus content in the range from 0.5 to 40% by weight, based on the phosphorus compound.

The invention further provides the use of a mixture of the flame retardant synergist a) and of the flame retardant b) as flame retardant system.

The invention further provides a polymer composition, preferably a polymer foam, particularly preferably a polymer foam based on a styrene polymer, comprising one or more polymers and the flame retardant system of the invention.

The invention also provides a process for rendering foamed or unfoamed polymers flame-retardant, where a melt of the polymer, or the monomers from which the polymer is produced, is/are mixed with the flame retardant system of the invention.

The invention also provides the use of the polymer composition of the invention as insulation material, in particular in the construction industry. The invention also provides the use of the polymer composition of the invention as packaging material.

The flame retardant system of the invention features by way of example improved processability during the production of foams based on styrene polymers. It is particularly suitable for providing fire protection to low-density foams.

It is advantageous that the effect as flame retardant system is not generally affected by addition of athermanous compounds.

The flame retardant system of the invention comprises one or more, preferably from 1 to 3, particularly preferably 1, compound(s) of the formula (I).

The definitions of the symbols and indices in the formula (I) are preferably as follows:
R is preferably C₆-C₁₂-aryl or a 5-10-membered heteroaryl group which comprises from one to three heteroatoms from the group of N, O, and S.
X is preferably OR², SR², NR²R³, COOR², CONR²R³, SO₂R², F, Cl, Br, H, or a Y¹—P(Y²)ₚR'R″ group.
Y¹ is preferably O or S.
Y² is preferably O or S.
p is preferably 0 or 1.
R′ and R″, being identical or different, are preferably C₁-C₁₈-alkyl, C₂-C₁₈-alkenyl, C₂-C₂₈-alkynyl, C₃-C₁₀-cycloalkyl, C₆-C₁₂-aryl, C₆-C₁₂-aryl-C₁-C₁₈-alkyl, O—(C₁-C₁₈)-alkyl, O—(C₃-C₁₀)-cycloalkyl, O—(C₆-C₁₂)-aryl, (C₆-C₁₂)-aryl-(C₁-C₁₈)-alkyl-O.
R¹ is preferably C₁-C₁₈-alkyl, C₂-C₁₈-alkenyl, C₂-C₁₈-alkynyl, C₃-C₁₀-cycloalkyl, O—(C₁-C₁₈)-alkyl, O—(C₂-C₁₈)-alkenyl, O—(C₂-C₁₈)-alkynyl, or O—(C₃-C₁₀)-cycloalkyl.
R² and R³, being identical or different, are preferably H, C₁-C₁₈-alkyl, C₂-C₁₈-alkenyl, C₂-C₁₈-alkynyl, C₃-C₁₀-cycloalkyl, C₆-C₁₀-aryl, or C₆-C₁₀-aryl-C₁-C₁₈-alkyl.
n is preferably an integer from 2 to 6.
m is preferably a number from 2 to 500.

Preference is given to compounds of the formula (I) in which the definitions of all of the symbols and indices are the preferred definitions.

Preference is also given to compounds of the formula (I) in which the definitions of the symbols and indices are the preferred definitions and R¹ is C₆-C₁₂-aryl.

It is particularly preferable that the definitions of the symbols and indices in the formula (I) are as follows:
R is particularly preferably C₆-C₁₀-aryl.
X is particularly preferably OR², SR², NR²R³, COOR², COONR²R³, SO₂R² or a Y¹—P(Y²)ₚR′R″ group.
Y¹ is particularly preferably O or S.
Y² is particularly preferably O or S.
p is particularly preferably 0 or 1.
R′ and R″ are particularly preferably identical, and are C₁-C₁₈-alkyl, C₆-C₁₂-aryl, O—(C₁-C₁₈)-alkyl, or O—(C₆-C₁₂-aryl).
R¹ is particularly preferably C₁-C₁₆-alkyl.
R² and R³ are particularly preferably identical, and are H, C₁-C₁₈-alkyl or C₆-C₁₂-aryl.
n is particularly preferably an integer from 2 to 4.
m is particularly preferably a number from 2 to 250.

Particular preference is given to compounds of the formula (I) in which the definitions of all of the symbols and indices are the particularly preferred definitions.

It is very particularly preferable that the definitions of the symbols and indices in the formula (I) are as follows:
R is very particularly preferably phenyl.
X is very particularly preferably OR² or an O—P(O)ₚR′R″ group.
p is very particularly preferably 0 or 1.
R′ and R″ are very particularly preferably identical and are C₁-C₆-alkyl, C₆-C₁₂-aryl, O—(C₁-C₆)-alkyl, or O—(C₆-C₁₂)-aryl.
R¹ is very particularly preferably a C₁-C₁₀-alkyl group.
R² is very particularly preferably H or a C₁-C₆-alkyl group.
n is very particularly preferably an integer from 2 to 3.
m is very particularly preferably a number from 3 to 150.

Very particular preference is given to compounds of the formula (I) in which the definitions of all of the symbols and indices are the very particularly preferred definitions. Very particular preference is likewise given to the sulfur content of from 15 to 40% by weight in the sulfur compounds (I), based on the sulfur compound (I).

With particular preference, the definitions of the symbols and indices in the formula (I) are as follows:
R is with particular preference phenyl, where the groups X and R¹ are in para-position.
X is with particular preference OH or an O—P(O)(O-phenyl)₂ group.
R¹ is with particular preference tert-C₄H₉ or tert-C₆H₁₁.
n is with particular preference 2.
m is with particular preference a number from 3 to 100.

Compounds of the formula (I) to which particular preference is given are those in which the definitions of all of the symbols and indices are the definitions to which particular preference is given.

Compounds to which particular preference is further given are the following, listed in the examples: poly(tert-butylphenol disulfide), poly(tert-amylphenol disulfide), and poly(tert-butylphenol disulfide) phosphated with diphenyl phosphate groups.

The sulfur content of the sulfur compounds (I) is preferably from 5 to 80% by weight, particularly preferably from 10 to 60% by weight, very particularly preferably from 15 to 40% by weight, based on the sulfur compound (I). The molar mass of the sulfur compounds (I) is preferably at least 500 g/mol.

Poly(tert-butylphenol disulfide) and poly(tert-amylphenol disulfide) are commercially obtainable from Arkema, Colombes, France. The synthesis of compounds of this type is described by way of example in U.S. Pat. No. 3,968,062.

The ratio by weight of sulfur compound(s) a) to phosphorus compound(s) b) is from 1:10 to 10:1, preferably from 1:8 to 8:1, particularly preferably from 1:5 to 5:1.

The flame retardant system of the invention comprises, as component b), one or more, preferably from 1 to 3, particularly preferably 1 or 2, in particular 1, phosphorus compound(s) with phosphorus content in the range from 5 to 80% by weight, based on phosphorus compound.

Examples of suitable phosphorus compounds are phosphates, phosphonates, such as DOPO (9,10-dihydro-9-oxa-10-phosphaphenanthrene 10-oxide) and DOPO derivatives, phosphinates, phosphites, and phosphinites. Examples of these are commercial products such as Exolit® OP 930, Exolit® OP 1312, HCA, HCA-HQ, Cyagard® RF-1243, Fyrol® PMP, Phoslite® IP-A, and Budit® 833.

Preference is given to phosphorus compounds of the formula (II),

(X¹)ₛ═PR⁴R⁵R⁶ (II)
where the definitions of the symbols and indices in the formula (II) are as follows:
R⁴ is C₁-C₁₆-alkyl, C₁-C₁₀-hydroxyalkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR¹², COR¹³, COOR¹⁴, CONR¹⁵R¹⁶;
R⁵ is C₁-C₁₆-alkyl, C₁-C₁₀-hydroxyalkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₈-alkyl, C₆-C₁₀-aryl-C₁-C₁₈-alkoxy, SR¹², COR¹³, COOR¹⁴, CONR¹⁵R¹⁶;
R⁶ is H, SH, OH, OR⁸ or a
   —(Y³)ᵥ—[P(═X²)ᵤR⁹—(Y⁴)ₖ]ₗ—P(═X³)ₜR¹⁰R¹¹ group;
or two groups R⁴, R⁵, or R⁶ form, together with the phosphorus atom bonded thereto, a ring system;
X¹, X², and X³, being identical or different, are mutually independently 0 or S;
Y³ and Y⁴, being identical or different, are O or S;
R⁷, R⁸_{, R}¹², R¹³, R¹⁴, R¹⁵, and R¹⁶, being identical or different, are C₁-C₁₂-alkyl or C₃-C₈-cycloalkyl which is unsubstituted or which has substitution by one or more C₁-C₄-alkyl groups, or are C₂-C₁₂-alkenyl, C₂-C₁₂-alkynyl, C₆-C₁₀-aryl, or C₈-C₁₀-aryl-C₁-C₄-alkyl, or hydroxy-(C₁-C₁₈)-alkyl;
R⁹, R¹⁰, and R¹¹, being identical or different, are mutually independently C₁-C₁₆-alkyl, C₂-C₁₆-alkenyl, C₁-C₁₆-alkoxy, C₁-C₁₆-alkenoxy, C₃-C₁₀-cycloalkyl, C₃-C₁₀-cycloalkoxy, C₈-C₁₀-aryl, C₆-C₁₀-aryloxy, C₆-C₁₀-aryl-C₁-C₁₈-alkyl, C₆-C₁₀-aryl-C₁-C₁₆-alkoxy, SR¹², COR¹³, COOR¹⁴, CONR¹⁵R¹⁶;
k and v are 0 or 1 if Y³ and, respectively, Y⁴ is 0, and are 1, 2, 3, 4, 5, 6, 7, or 8 if Y² and, respectively, Y⁴ is S, and
I is an integer from 0 to 100;
s, t, and u are mutually independently 0 or 1.

It is preferable that the definitions of the symbols and indices of the formula (II) are as follows:
R⁴ is preferably C₁-C₁₆-alkyl, C₁-C₁₀-hydroxyalkyl, C₂-C₁₆-alkenyl, C₁-C₁₈-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy.

R⁵ is preferably C₁-C₁₆-alkyl, C₁-C₁₀-hydroxyalkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryl-C₁-C₁₆-alkyl, C₆-C₁₀-aryl-C₁-C₁₆-alkoxy.
R⁶ is preferably H, SH, SR⁷, OH, OR⁸ or a group:

—(Y³)ᵥ—[P(═X²)ᵤR⁹—(Y⁴)ₖ]ₗ—P(═X³)ₜR¹⁰R¹¹.
X¹, X², and X³, being identical or different, are preferably mutually independently O or S.
Y³ and Y⁴, being identical or different, are preferably O or S.
R⁷ and R⁸, being identical or different, are preferably C₁-C₁₂-alkyl or C₃-C₈-cycloalkyl which is unsubstituted or which has substitution by one or more C₁-C₄-alkyl groups, or are C₂-C₁₂-alkenyl, C₂-C₁₂-alkynyl, C₆-C₁₀-aryl, or C₆-C₁₀-aryl-C₁-C₄-alkyl.
R⁹, R¹⁰, and R¹¹, being identical or different, are preferably mutually independently C₁-C₁₆-alkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR¹², COR¹³, COOR¹⁴, CONR¹⁵R¹⁶.
k and v are preferably 1 if Y³ and, respectively, Y⁴ is O, and 1 or 2 if Y³ and, respectively, Y⁴ is S.
I is preferably an integer from 0 to 10.
s, t, and u are preferably 1.

Preference is given to compounds of the formula (II) in which the definitions of all of the symbols and indices are the preferred definitions.

Preference is also given to compounds of the formula (II) in which two radicals R⁴, R⁵, or R⁶ do not together form a ring system.

It is particularly preferable that the definitions of the symbols and indices in the formula (II) are as follows:
R⁴ is particularly preferably C₁-C₈-alkyl, C₁-C₈-alkoxy, cyclohexyl, phenyl, phenoxy, benzyl, or benzyloxy.
R⁵ is particularly preferably C₁-C₈-alkyl, C₁-C₈-alkoxy, cyclohexyl, phenyl, benzyl, or benzyloxy.
R⁶ is particularly preferably H, SH, SR⁷, OH, OR⁸, or a —(Y³)ₖ—P(═X³)ₜR¹⁰R¹¹ group.
X¹ and X³, being identical or different, are particularly preferably O or S.
Y³ is particularly preferably O or S.
R⁷ and R⁸, being identical or different, are particularly preferably C₁-C₈-alkyl, cyclohexyl, phenyl, or benzyl.
R¹⁰ and R¹¹, being identical or different, are particularly preferably C₁-C₈-alkyl, C₁-C₈-alkoxy, cyclohexyl, phenyl, phenoxy, benzyl, or benzyloxy.
k is particularly preferably 1 if Y³ is 0, and 1 or 2 if Y³ is S.
s and t are particularly preferably 1.

Particular preference is given to compounds of the formula (II) in which the definitions of the symbols and indices are the particularly preferred definitions.

With particular preference, the definitions of the symbols and indices in the formula (II) are as follows:
R⁴ is with particular preference phenyl or phenoxy.
R⁵ is with particular preference phenyl.
R⁶ is with particular preference H, SH, SR', OH, OR⁸, or a —(Y³)ₖ—P(═X³)ₜR¹⁰R¹¹ group.
X¹ and X³, being identical or different, are with particular preference O or S.
Y³ is with particular preference O or S.
R⁷ and R⁸, being identical or different, are with particular preference cyclohexyl, phenyl, or benzyl.
R¹⁰ and R¹¹, being identical or different, are with particular preference phenyl or phenoxy.
k is with particular preference 1 if Y³ is O, and 1 or 2 if Y³ is S.
s and t are with particular preference 1.

Compounds of the formula (II) to which particular preference is given are those in which the definitions of the symbols and indices are the definitions to which particular preference is given.

Compounds of the formula (II) to which particular preference is further given are those in which the definitions of the symbols and indices are the definitions to which particular preference is given and R⁵ is phenoxy.

Preference is further given to the following groups of compounds of the formula (II):

S═PR⁴R⁵—H (IIa)

S═PR⁴R⁵—SH (IIb)

S═PR⁴R⁵—OH (IIc)

S═PR⁴R⁵—S-phenyl (IId)

S═PR⁴R⁵—O-phenyl (IIe)

S═PR⁴R⁵—S-benzyl (IIf)

S═PR⁴R⁵—O-benzyl (IIg)

S═PR⁴R⁵—P(═S)R¹⁰R¹¹ (IIh)

S═PR⁴R⁵—S—P(═S)R¹⁰R¹¹ (IIi)

S═PR⁴R⁵—S—S—P(═S)R¹⁰R¹¹ (IIj)

S═PR⁴R⁵—O—P(═S)R¹⁰R¹¹ (IIk)

O═PR⁴R⁵—H (IIl)

O═PR⁴R⁵—SH (IIm)

O═PR⁴R⁵—OH (IIn)

O═PR⁴R⁵—S-phenyl (IIo)

O═PR⁴R⁵—O-phenyl (IIp)

O═PR⁴R⁵—S-benzyl (IIq)

O═PR⁴R⁵—P(═S)R¹⁰R¹¹ (IIr)

O═PR⁴R⁵—S—P(═S)R¹⁰R¹¹ (IIs)

O═PR⁴R⁵—S—S—P(═S)R¹⁰R¹¹ (IIt)

O═PR⁴R⁵—O—P(═S)R¹⁰R¹¹ (IIu)

O═PR⁴R⁵—P(═O)R¹⁰R¹¹ (IIv)

O═PR⁴R⁵—S—P(═O)R¹⁰R¹¹ (IIw)

O═PR⁴R⁵—S—S—P(═O)R¹⁰R¹¹ (IIx)

O═PR⁴R⁵—O—P(═O)R¹⁰R¹¹ (IIy)

where the definitions of the symbols are as stated in the formula (II).

Components b) to which particular preference is given are the following:

| | |
|---|---|
| 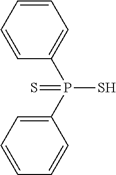 | Diphenyldithiophosphinic acid |
| 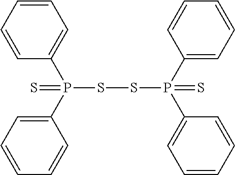 | Bis(diphenylphosphinethioyl) disulfide |
| 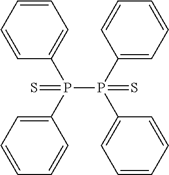 | 1,1,2,2-Tetraphenyldiphosphine disulfide |
| O═P(O—Ph)₃ | Triphenyl phosphate |

Phosphorus compounds to which further preference is given are those of the formula (III),

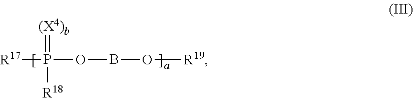

where the definitions of the symbols and indices in the formula (III) are as follows:
B is a

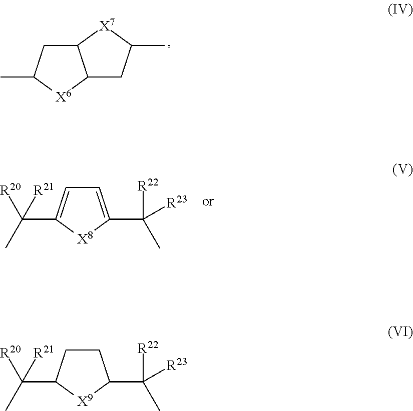

group
R¹⁹ is —P(═X⁵)_{c}R²⁴R²⁵, H, a straight-chain or branched C₁-C₁₂-alkyl group, C₅-C₆-cycloalkyl, C₆-C₁₂-aryl, or benzyl, where the four last-mentioned groups are unsubstituted or have substitution by one or more radicals from the group of C₁-C₄-alkyl and C₂-C₄-alkenyl;
R¹⁷, R¹⁸, R²⁴, and R²⁵, being identical or different, are hydrogen, OH, C₁-C₁₆-alkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR²⁶COR²⁷, COOR²⁸, CONR²⁹R³⁰, or two radicals R¹⁷, R¹⁸, R²⁴, or R²⁵ form, together with the phosphorus atom bonded thereto, or together with a P—O—B—O—P group, a ring system;
R²⁰, R²¹, R²², and R²³, being identical or different, are H, C₁-C₁₆-alkyl, C₂-C₁₆-alkenyl, C₁-C₁₆-alkoxy, C₂-C₁₆-alkenoxy;
R²⁶, R²⁷, R²⁸, R²⁹, and R³⁰, being identical or different, are H, C₁-C₁₆-alkyl, C₂-C₁₆-alkenyl, C₆-C₁₀-aryl, C₆-C₁₀-aryl-C₁-C₁₆-alkyl, C₆-C₁₀-aryl-C₁-C₁₅-alkoxy;
X⁴ and X⁵, being identical or different, are S or O;
b and c, being identical or different, preferably identical, are 0 or 1;
X⁶, X⁷, X⁸, and X⁹, being identical or different, are S or O, and
a is a natural number from 1 to 50.

It is preferable that the definitions of the symbols in the formula (III) are as follows:

B is preferably a group of the formula (IV), (V), or (VI).
R¹⁹ is preferably (X⁵)_{c}PR²⁴R²⁵ or H.
R¹⁷, R¹⁸, R²⁴, and R²⁵, being identical or different, are preferably C₆-C₁₀-aryl, C₆-C₁₀-aryloxy, C₆-C₁₀-aryl-C₁-C₁₆-alkyl, or C₆-C₁₀-aryl-C₁-C₁₆-alkoxy.
R²⁰, R²¹, R²², and R²³ are preferably H, C₁-C₁₆-alkyl, C₂-C₁₆-alkenyl, C₁-C₁₆-alkoxy, C₁-C₁₆-alkenoxy.
X⁴ and X⁵, being identical or different, are preferably S or O.
b and c are preferably 0 or 1.
X⁶, X⁷, X⁸, and X⁹ are preferably O.
a is preferably a natural number from 1 to 30.

Preference is given to compounds of the formula (III) in which the definitions of all of the symbols are the preferred definitions.

It is particularly preferable that the definitions of the symbols in the formula (III) are as follows:

B is particularly preferably a group of the formula (IV), (V), or (VI).
R¹⁹ is particularly preferably (X⁵)_{c}PR²⁴R²⁵.
R¹⁷, R¹⁸, R²⁴, and R²⁵, being identical or different, are particularly preferably phenyl, phenoxy, phenyl-C₁-C₁₆-alkyl, or phenyl-C₁-C₁₆-alkoxy.
R²⁰, R²¹, R²², and R²³ are particularly preferably H.
X⁴ and X⁵, being identical or different, are particularly preferably S or O.
b and c are particularly preferably 0 or 1.
X⁶, X⁷, X⁸, and X⁹ are particularly preferably O.
a is particularly preferably 1.

Particular preference is given to compounds of the formula (III) in which the definitions of all of the symbols and indices are the particularly preferred definitions.

Preference is given to compounds of the formula (III) in which R¹⁷ and R¹⁸ are identical.

Preference is further given to compounds of the formula (III) in which R¹⁷ and R²⁴ or R¹⁷ and R²⁵ are identical. Particular preference is further given to compounds of the formula (III) in which R¹⁸ and R²⁴ or R¹⁸ and R²⁵ are identical.

Preference is further given to compounds in which R¹⁷, R¹⁸, R²⁴, and R²⁵ are identical.

With particular preference, the definitions of the symbols and indices in the formula (III) are as follows:

B is with particular preference a group of the formula (IV), (V), or (VI).
R¹⁹ is with particular preference (X⁵)_{c}PR²⁴R²⁵.
R¹⁷, R¹⁸, R²⁴, and R²⁵ are with particular preference identical and are phenyl or phenoxy.
R²⁰, R²¹, R²², and R²³ are with particular preference H.
X⁴ and X⁵ are with particular preference S or O.
b and c are with particular preference identical and are 0 or 1.
X⁶, X⁷, X⁹, and X⁹ are with particular preference oxygen.
a is with particular preference 1.

Compounds of the formula (III) to which particular preference is given are those in which the definitions of all of the symbols and indices are the definitions to which particular preference is given.

Preference is also given to compounds of the formula (III) in which respectively two of the radicals R¹⁷, R¹⁸, R²⁴, and R²⁵, together with the phosphorus atom bonded thereto, or together with the group P—O—B—O—P—, form a three- to twelve-membered ring system.

Preference is further given to compounds of the formula (III) in which two radicals R¹⁷, R¹⁸, R²⁴, R²⁵ do not together form a ring system.

Compounds to which particular preference is further given are the following compounds of the formula (III):

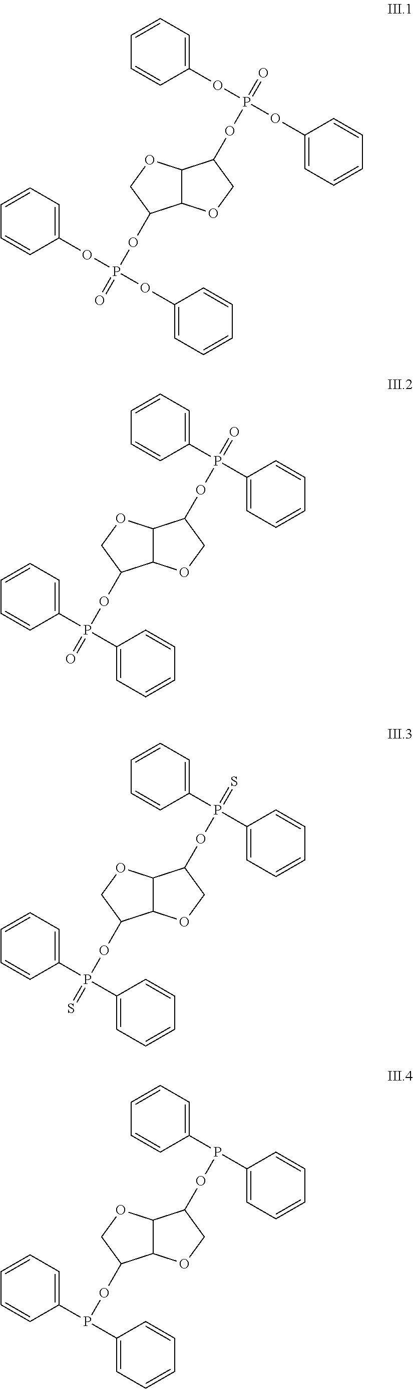

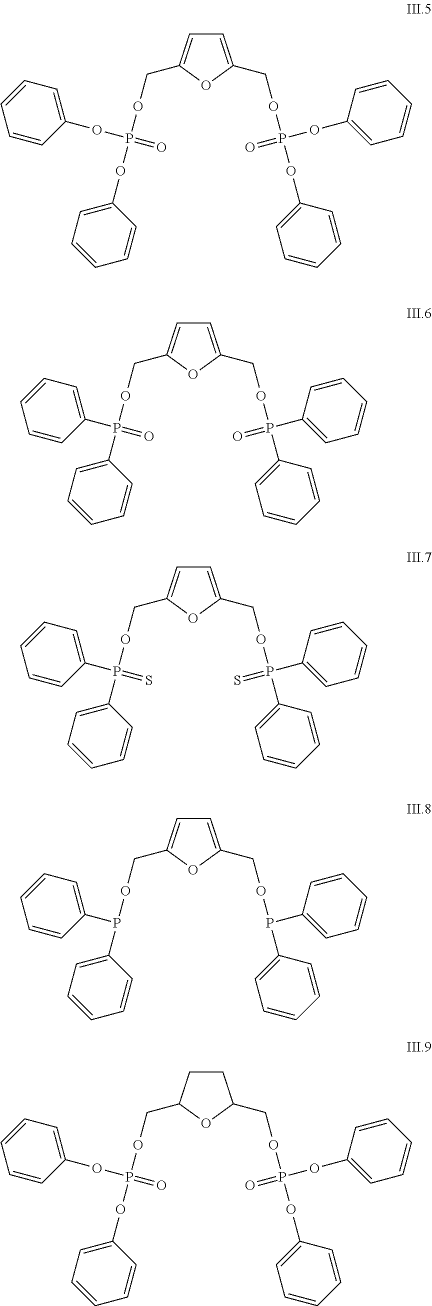

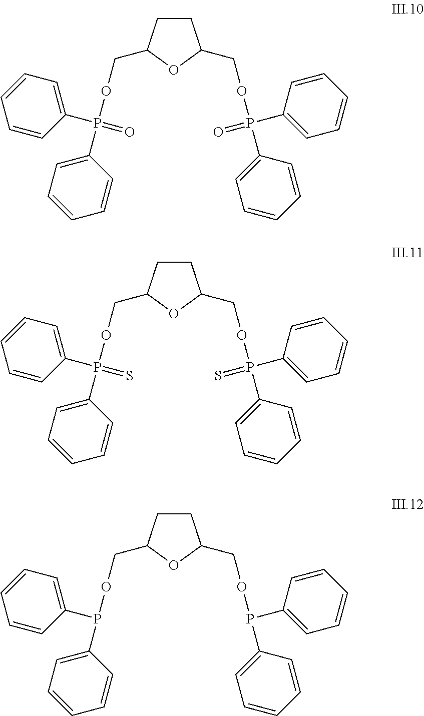

Some of the compounds of the formula (III) are known from the literature. They are synthesized by way of example by reacting the corresponding furan- or thiophene-based parent diol structures with chlorophosphorus compounds in the presence of a base. The type of reaction that underlies this process is the reaction of chlorophosphorus compounds with alcohols, which is widely described in the literature [see, for example, WO-A 2003/062251; Dhawan, Balram; Redmore, Derek. J. Org. Chem. (1986), 51(2), 179-83; WO 96/17853; Kumar, K. Ananda; Kasthuraiah, M.; Reddy, C. Suresh; Nagaraju, C. Heterocyclic Communications (2003), 9(3), 313-318; Givelet, Cecile; Tinant, Bernard; Van Meervelt, Luc; Buffeteau, Thierry; Marchand-Geneste, Nathalie; Bibal, Brigitte. J. Org. Chem. (2009), 74(2), 652-659.]

The furan- or thiophene-based parent diol structures are mostly commercially available or can easily be prepared by methods known from the literature, starting from sugars [see, for example: WO 2006/063287 (preparation of 2,5-bis(hydroxymethyl)-tetrahydrofuran); Cottier, Louis; Descotes, Gerard; Soro, Yaya. Synth. Comm. (2003), 33(24), 4285-4295 (preparation of 2,5-bis(hydroxymethyl)furan); CA 2196632, Katritzky, Alan R.; Zhang, Zhongxing; Lang, Hengyuan; Jubran, Nusrallah; Leichter, Louis M.; Sweeny, Norman. J. Heterocycl. Chem. (1997), 34(2), 561-565].

The preparation of 2,5-substituted furan-based derivatives is also well known from the literature (R⁵-R⁸ being entirely or to some extent identical or different and not equal to H):
e.g. the preparation of α2,α5-arylated 2,5-bis(hydroxymethyl)furans: Ishii, Akihiko; Horikawa, Yasuaki; Takaki, Ikuo; Shibata, Jun; Nakayama, Juzo; Hoshino, Masamatsu. Tetrahedron Lett. (1991), 32(34), 4313-16; Jang, Yong-Sung; Kim, Han-Je; Lee, Phil-Ho; Lee, Chang-Hee. Tetrahedron Lett. (2000), 41(16), 2919-2923, or
e.g. the preparation of α2,α5-alkylated 2,5-bis(hydroxymethyl)furans: Krauss, Juergen; Unterreitmeier, Doris; Antlsperger, Dorothee. Archiv der Pharmazie (2003), 336(8), 381-384.
e.g. the preparation of α2,α5-alkylated 2,5-bis(hydroxymethyl)tetrahydrofurans: Walba, D. M.; Wand, M. D.; Wilkes, M. C. J. Am. Chem. Soc. (1979), 101(15), 4396-4397.
e.g. the preparation of α2,α5-alkenylated 2,5-bis(hydroxymethyl)tetrahydrofurans: Morimoto, Yoshiki; Kinoshita, Takamasa; Iwai, Toshiyuki. Chirality (2002), 14(7), 578-586.

The synthesis of asymmetrically 2,5-substituted furan-based diols of this type is also known from the literature, e.g. the preparation of α2-alkylated 2,5-bis(hydroxymethyl)tetrahydrofurans: Donohoe, Timothy J.; Williams, Oliver; Churchill, Gwydian H. Angew. Chem. Int. Ed. (2008), 47(15), 2869-2871; or the synthesis of α2-alkylated, α5-alkynylated 2,5-bis(hydroxymethyl)tetrahydrofurans: Abe, Masato; Kubo, Akina; Yamamoto, Shuhei; Hatoh, Yoshinori; Murai, Masatoshi; Hattori, Yasunao; Makabe, Hidefumi; Nishioka, Takaaki; Miyoshi, Hideto. Biochemistry (2008), 47(23), 6260-6266;

or the preparation of α2-alkoxylated 2,5-bis(hydroxymethyl)furans: Lu, Dan; Li, Pingya; Liu, Jinping; Li, Haijun, CN 101544624 A.

The synthesis of the thio analogs (X═S) of (II) is also known from the literature [cf. Kuszmann, J.; Sohar, P. Carbohydrate Research (1972), 21(1), 19-27].

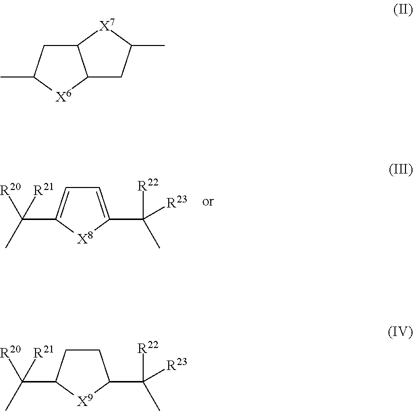

Likewise known are the synthesis of the thio analogs (X═S) of (III) [cf. Garrigues, Bernard. Phosphorus, Sulfur and Silicon (1990), 53(1-4), 75-9] and of substituted thio analogs of III, e.g. α2,α5-arylated 2,5-bis(hydroxymethyl)thiophenes [cf. Kumaresan, D.; Agarwal, Neeraj; Gupta, Iti; Ravikanth, M. Tetrahedron (2002), 58(26), 5347-5356].

The synthesis of the thio analogs (X═S) of (IV) and substituted thio analogs of IV, e.g. α2,α5-alkylated 2,5-bis(hydroxymethyl)tetrahydrothiophenes, has moreover been described [cf. Luttringhaus, A.; Merz, H. Archiv der Pharmazie and Berichte der Deutschen Pharmazeutischen Gesellschaft [Archive of pharmacy and reports of the German Pharmaceutical Society] (1960), 293, 881-890 and, respectively, Block, Eric; Ahmad, Saleem. Phosph. Sulfur and the Related Elements (1985), 25(2), 139-145].

Some of the furan- or thiophene-based diols occur in enantiomerically or diastereomerically pure form. The furan- or thiophene-based diols can be used in the form of their pure enantiomers or diastereomers. However, preference is given to mixtures of the respective geometric isomers.

The chlorophosphorus derivatives needed for the synthesis of the flame retardant agonists are usually available commercially or can be prepared by way of synthesis routes well known from the literature [cf. Science of Synthesis (formerly Houben Weyl) 42 (2008); Houben Weyl E1-2 (1982); Houben Weyl 12 (1963-1964)].

Preference is further given to oligomeric or polymeric phosphates of the formula (VII) as phosphorus compounds b),

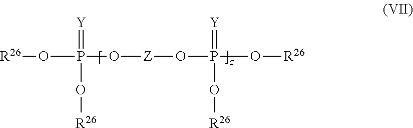

where the definitions of the symbols and indices are as follows:
R²⁶, R²⁷, R²⁸, and R²⁹, being identical or different, are H, linear or branched C₁-C₁₆-alkyl, linear or branched C₂-C₁₆-alkenyl, linear or branched C₂-C₁₆-alkynyl, C₃-C₁₀-cycloalkyl, C₆-C₁₀-aryl, heteroaryl, or C₆-C₁₀-aryl-C₁-C₁₀-alkyl, where aryl in the moieties R²⁶-R²⁸ is respectively mutually independently unsubstituted or has substitution by from 1 to 3 moieties from the group of C₁-C₁₀-alkyl, C₁-C₁₀-alkoxy, C₆-C₁₀-aryl, C₆-C₁₀-aryloxy, OH, CHO, COOH, CN, SH, SCH₃, SO₂CH₃, SO₂—C₆-C₁₀-aryl, SO₃H, COCH₃, COC₂H₅, CO—C₆-C₁₀-aryl, and S—S—C₆-C₁₀-aryl, or
R²⁶, R²⁷, R²⁸, and R²⁹ are a cationic moiety from the group of the metals, preferably alkali metals, alkaline earth metals, Al, Zn; and also of nitrogen-containing cations, in particular ammonium,
Z is

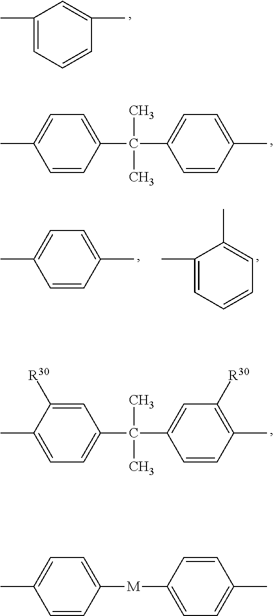

M is —CH₂—, —C(CF₃)₂—, —C(CH₃)(C₆H₅)—, —C(CH₃)(C₂H₅)—, —C(C₆H₅)₂-1,3-phenylene-C(CH₃)₂—, —C(CH₃)₂-1,4-phenylene-C(CH₃)₂—,

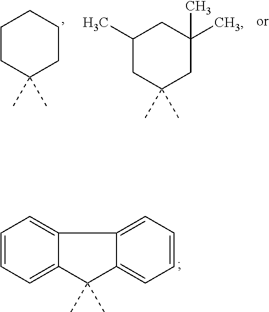

R³° is —CH₃, —CH(CH₃)₂, or C₆H₅, and
n is from 1 to 100.

It is preferable that the definitions of the symbols and indices in the formula VII are as follows:
R³⁰ is preferably phenyl.
Z is preferably

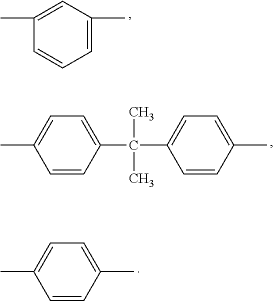

n is preferably from 1 to 50, particularly preferably from 1 to 10.

Preference is given to compounds of the formula VII in which the definitions of all of the symbols and indices are the preferred definitions.

Particularly preferably compounds of the formula (VII) are the compounds (VII-1) and (VII-2):

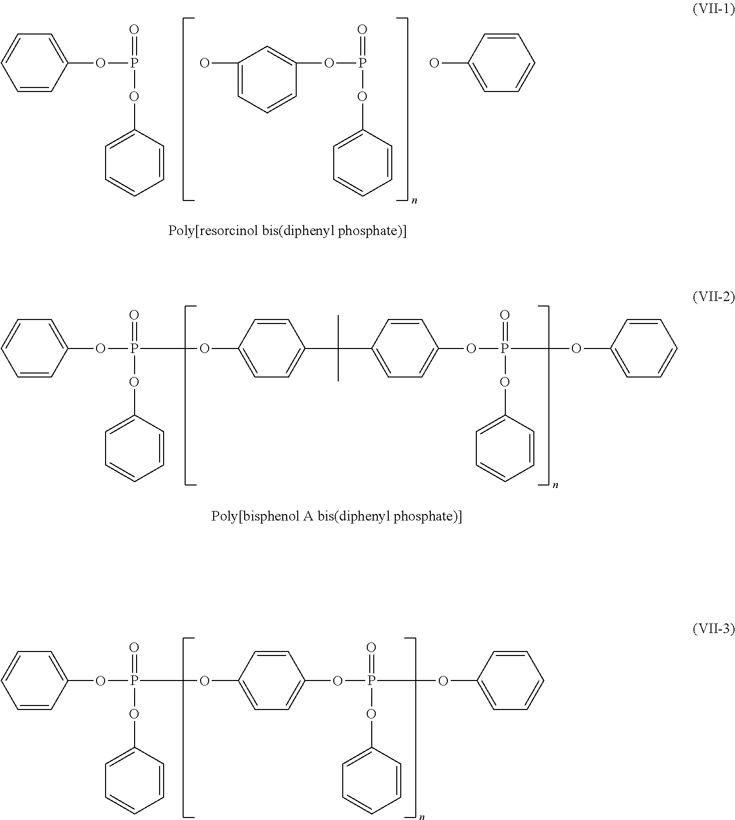

The compounds of the formula (VII) are known and to some extent available commercially, for example the compound (VII-1) as Fyrolflex® RDP from ICL-IP-Europe BV, and the compound (VII-2) as Fyrolflex® BDP from ICL-IP-Europe BV.

Preference is further given to oligomeric or polymeric phosphonates of the formula (VIII) as phosphorus compounds b),

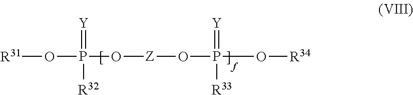

where the definitions of the symbols and indices are as follows:
R³¹, R³², R³³, and R³⁴, being identical or different, are H, linear or branched C₁-C₁₆-alkyl, linear or branched C₂-C₁₆-alkenyl, linear or branched C₂-C₁₆-alkynyl, C₃-C₁₀-cycloalkyl, C₆-C₁₀-aryl, heteroaryl, or C₆-C₁₀-aryl-C₁-C₁₀-alkyl; where aryl in the moieties R³⁰-R³³ is respectively mutually independently unsubstituted or has substitution by from 1 to 3 moieties from the group of C₁-C₁₀-alkyl, C₁-C₁₀-alkoxy, C₆-C₁₀-aryl, C₆-C₁₀-aryloxy, OH, CHO, COOH, CN, SH, SCH₃, SO₂CH₃, SO₂—C₆-C₁₀-aryl, SO₃H, COCH₃, COC₂H₅, CO—C₆-C₁₀-aryl, and S—S—C₆-C₁₀-aryl;

### Z is

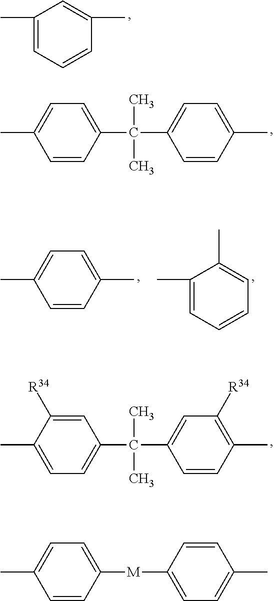 [0182] M is —CH₂—, —C(CF₃)₂—, —C(CH₃)(C₆H₅)—, —C(CH₃)(C₂H₅)—, —C(C₆H₅)₂-1,3-phenylene-C(CH₃)₂—, —C(CH₃)₂-1,4-phenylene-C(CH₃)₂—, —O—, —S—,

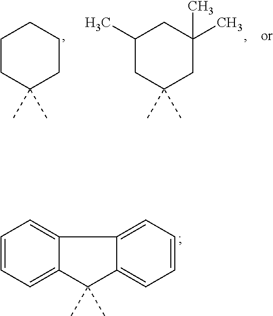

### R³⁴ is —CH₃, —CH(CH₃)₂, or C₆H₅, and

f is from 1 to 1000.

It is preferable that the definitions of the symbols and indices in the formula (VIII) are as follows:

R³¹ and R³⁴ are preferably phenyl.
R³² and R³³ are preferably phenyl, methyl, ethyl.
Z is preferably

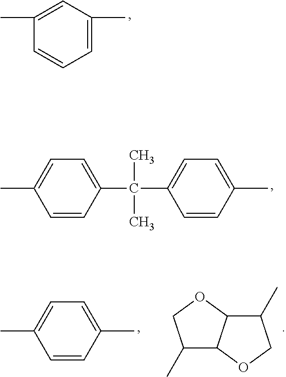

f is preferably from 1 to 1000, particularly preferably from 100 to 500.

Preference is given to compounds of the formula (VIII) in which the definitions of all of the symbols and indices are the preferred definitions.

Particularly preferred compounds of the formula (VIII) are the compounds (VIII-1) and (VIII-2):

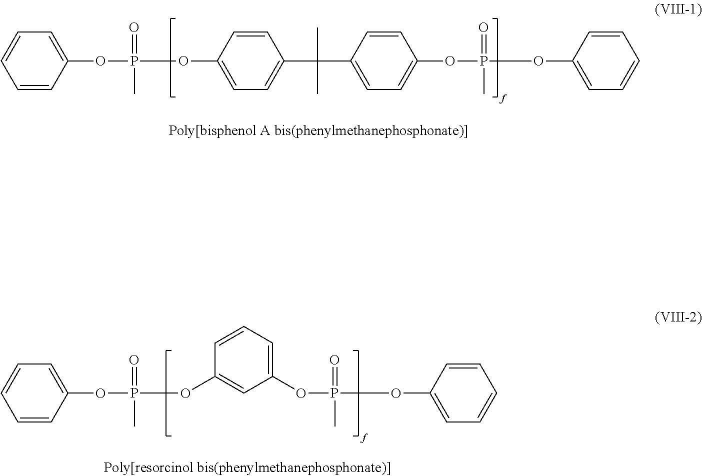

The compounds of the formula (VIII), and derivatives thereof are known and to some extent available commercially, an example being the compound (VIII-1) as FRX100® from FRX Polymers (USA). The flame retardant system of the invention, made of the abovementioned sulfur compounds and of the abovementioned phosphorus compounds is generally used to protect polymers, in particular polymer foams. Amounts of from 2 to 15 parts by weight, based on the polymer, preferably from 5 to 10 parts by weight, based on the polymer, ensure adequate flame retardancy in particular in the case of foams made of expandable styrene polymers.

Preference is likewise given to use of an amount in the range from 0.2 to 20 parts by weight, based on the polymer. Amounts of from 0.5 to 15 parts by weight, based on the polymer, preferably from 0.75 to 10 parts by weight, based on the polymer, particularly preferably from 1 to 5 parts by weight, based on the polymer, ensure adequate flame retardancy in particular in the case of foams made of expandable styrene polymers.

If compounds of the formula VII are used as phosphorus compounds b), the amount used of the flame retardant system of the invention (i.e. the entirety of components a) and b)) is preferably 5 parts by weight, based on 100 parts by weight of polymer.

For the purposes of this application—unless otherwise stated—the parts-by-weight data are always based on 100 parts by weight of the compound, in particular of the polymer, which is rendered flame-retardant, ignoring any additives.

The effectiveness of the flame retardant system of the invention can be still further improved through addition of further suitable flame retardant synergists, examples being the thermal free-radical generators dicumyl peroxide, di-tert-butyl peroxide. The amounts usually used of the flame retardant synergist in this case, based on the polymer, are from 0.05 to 5 parts by weight. Preference is equally given to the use of 2,5-dimethyl-2,5-di-(tert-butylperoxy)hex-3-yne, cumyl hydroperoxide, 1,3-bis(tert-butyl-peroxyisopropyl)benzene, and 1,4-bis(tert-butylperoxyisopropyl)benzene in the amounts mentioned.

Other flame retardants can also be used, examples being melamine, melamine cyanurates, metal oxides, metal hydroxides, phosphates, phosphonates, DOPO (9,10-dihydro-9-oxa-10-phosphaphenanthrene 10-oxide, or DOPO derivatives, phosphinates, phosphites, phosphinites, expandable graphite, or synergists, such as Sb₂O₃, Sn compounds, or compounds which contain or liberate nitroxyl radicals. Suitable additional halogen-free flame retardants are available commercially by way of example as Exolit® OP 930, Exolit® OP 1312, HCA®, HCA-HQ®, Cyagard® RF-1243, Fyrol® PMP, Phoslite® IP-A, Melapur® 200, Melapur® MC or Budit® 833.

If complete freedom from halogen is not essential, it is possible to produce reduced-halogen-content materials by using the flame retardant of the invention and adding relatively small amounts of halogen-containing, in particular brominated, flame retardants, such as hexabromocyclododecane (HBCD), or brominated styrene homo- or copolymers/oligomers (e.g. styrene-butadiene copolymers, as described in WO-A 2007/058736), preferably in amounts in the range from 0.05 to 1 part by weight, in particular from 0.1 to 0.5 part by weight (based on the polymer).

In one preferred embodiment, the flame retardant system of the invention is halogen-free.

It is particularly preferable that the composition made of polymer, of flame retardant system, and of further additives is halogen-free.

The material to be protected in the invention is preferably a polymer composition, i.e. a composition which comprises one or more polymers and preferably consists of one or more polymers. Preference is given to thermoplastic polymers. The polymer composition is particularly preferably a foam.

The flame retardant systems of the invention are preferably used for producing flame-retardant polymers, in particular thermoplastic polymers. For this, the flame retardant systems are preferably mixed physically with the corresponding polymer in the melt, and then, either in the form of polymer mixture with phosphorus content of from 0.05 part by weight to 5 parts by weight and sulfur content of from 0.1 part by weight to 10 parts by weight (based on the polymer), first subjected to a complete compounding process, and then further processed in a second step together with the same polymer or with another polymer. As an alternative, in the case of styrene polymers, preference is also given to the addition of the flame retardant system of the invention prior to, during, and/or after production via suspension polymerization.

The invention also provides a, preferably thermoplastic, polymer composition comprising one or more polymers and the flame retardant system of the invention.

Examples of polymers that can be used are foamed or unfoamed styrene polymers, inclusive of ABS, ASA, SAN, AMSAN, SB, and HIPS polymers, polyimides, polysulfones, polyolefins, such as polyethylene and polypropylene, polyacrylates, polyetheretherketones, polyurethanes, polycarbonates, polyphenylene oxides, unsaturated polyester resins, phenolic resins, aminoplastics, epoxy resins, polyamides, polyether sulfones, polyether ketones, and polyether sulfides, in each case individually or in a mixture in the form of polymer blends.

Preference is given to thermoplastic polymers, such as foamed or unfoamed styrene homo- and copolymers, in each case individually or in a mixture in the form of polymer blends.

Preference is given to flame-retardant polymer foams, in particular those based on styrene polymers, preferably EPS and XPS.

The density of the flame-retardant polymer foams (to ISO 845) is preferably in the range from 5 to 150 kg/m³, particularly preferably in the range from 10 to 50 kg/m³, and their proportion of closed cells is preferably more than 80%, particularly preferably from 90 to 100%.

Flame-retardant, expandable styrene polymers (EPS) and extruded styrene polymer foams (XPS) of the invention can be processed via addition of the blowing agent and of the flame retardant system of the invention prior to, during, or after the suspension polymerization reaction, or via mixing to incorporate a blowing agent and the flame retardant system of the invention into the polymer melt and subsequent extrusion and pelletization under pressure to give expandable pellets (EPS), or via extrusion and depressurization with use of appropriately shaped dies, to give foam sheets (XPS) or foam strands.

The expression styrene polymer in the invention covers polymers based on styrene, alpha-methylstyrene, or a mixture of styrene and alpha-methylstyrene; this also applies analogously to the styrene content in SAN, AMSAN, ABS, ASA, MBS, and MABS (see below). Styrene polymers of the invention are based on at least 50% by weight of styrene and/or alpha-methylstyrene monomers.

In one preferred embodiment, the polymer is an expandable polystyrene (EPS).

In another preferred embodiment, the foam is an extruded styrene polymer foam (XPS).

The molar mass M_{W} of expandable styrene polymers is preferably in the range from 180 000 to 300 000 g/mol, measured by means of gel permeation chromatography with refractiometric detection (RI) against polystyrene standards. The molar mass of the expandable polystyrene is generally below the molar mass of the polystyrene used by about 10 000 to 40 000 g/mol, because of molar mass degradation due to shear and/or the effect of temperature. The number-average molar mass Mₙ is preferably smaller than 120 000 g/mol.

Styrene polymers are preferably glassclear polystyrene (GPPS), high-impact polystyrene (HIPS), anionically polymerized polystyrene or impact-resistant polystyrene (AIPS), styrene-alpha-methylstyrene copolymers, acrylonitrile-butadiene-styrene polymers (ABS), styrene-butadiene copolymers (SB), styrene-acrylonitrile copolymers (SAN), acrylonitrile-alpha-methylstyrene copolymers (AMSAN), styrene-maleic anhydride copolymers (SMA), styrene-methyl methacrylate copolymers (SMMA), styrene-N-phenylmaleimide copolymers (SPMI), acrylonitrile-styrene-acrylate (ASA), methyl methacrylate-butadiene-styrene (MBS), methyl methacrylate-acrylonitrile-butadiene-styrene (MABS) polymers, or a mixture thereof, or with polyphenylene ether (PPE).

In order to improve mechanical properties or thermal stability, the styrene polymers mentioned may be blended with thermoplastic polymers, such as polyamides (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfones (PES), polyether ketones or polyether sulfides (PES) or a mixture of these, generally in total proportions of up to a maximum of 30% by weight, preferably in the range from 1 to 10% by weight, based on the polymer melt, optionally with use of compatibilizers. Mixtures within the ranges of amounts mentioned are also possible with, by way of example, hydrophobically modified or functionalized polymers or oligomers, rubbers, such as polyacrylates or polydienes, e.g. styrene-butadiene block copolymers, or biodegradable aliphatic or aliphatic/aromatic copolyesters.

Examples of suitable compatibilizers are maleic-anhydride-modified styrene copolymers, polymers containing epoxy groups, and organosilanes.

The styrene polymer melt can also receive admixtures of polymer recyclates of the abovementioned thermoplastic polymers, in particular styrene polymers and expandable styrene polymers (EPS), in amounts which do not substantially impair their properties, generally amounts of at most 50% by weight, in particular amounts of from 1 to 20% by weight.

The styrene polymer melt comprising blowing agent generally comprises one or more blowing agents homogeneously distributed in a total proportion of from 2 to 10% by weight, preferably from 3 to 7% by weight, based on the styrene polymer melt comprising blowing agent. Suitable blowing agents are the physical blowing agents usually used in EPS, such as aliphatic hydrocarbons having from 2 to 7 carbon atoms, alcohols, ketones, ethers, or halogenated hydrocarbons. Preference is given to use of isobutane, n-butane, isopentane, n-pentane. For XPS, it is preferable to use CO₂ or a mixture thereof with alcohols and/or with C₂-C₄ carbonyl compounds, in particular with ketones.

To improve foamability, finely dispersed droplets of internal water may be introduced into the styrene polymer matrix. An example of the method for this is the addition of water into the molten styrene polymer matrix. The location of addition of the water may be upstream of, together with, or downstream of, the blowing agent feed. Homogeneous distribution of the water may be achieved by using dynamic or static mixers. An adequate amount of water, based on the styrene polymer, is generally from 0 to 2% by weight, preferably from 0.05 to 1.5% by weight.

Expandable styrene polymers (EPSs) with at least 90% of the internal water in the form of droplets of internal water with diameter in the range from 0.5 to 15 μm form, on foaming, foams with an adequate number of cells and with homogeneous foam structure.

The amount added of blowing agent and of water is selected in such a way that the expansion capability a of the expandable styrene polymers (EPSs), defined as bulk density prior to foaming/bulk density after foaming, is at most 125, preferably from 15 to 100.

The bulk density of the expandable styrene polymer pellets (EPSs) of the invention is generally at most 700 g/l, preferably in the range from 590 to 660 g/l. If fillers are used, bulk densities in the range from 590 to 1200 g/1 may arise, depending on the nature and amount of the filler.

Additives, nucleating agents, fillers, plasticizers, soluble and insoluble inorganic and/or organic dyes and pigments, e.g. IR absorbers, such as carbon black, graphite, or aluminum powder, and also other athermanous materials can moreover be added, together or with spatial separation, to the styrene polymer melt, e.g. by way of mixers or ancillary extruders. The amounts generally added of the dyes and pigments are in the range from 0.01 to 30% by weight, preferably in the range from 1 to 5% by weight. In order to achieve homogeneous microdispersion of the pigments in the styrene polymer, it can be advantageous in particular in the case of polar pigments to use a dispersing agent, e.g. organosilanes, polymers containing epoxy groups, or maleic-anhydride-grafted styrene polymers. Preferred plasticizers are mineral oils and phthalates, and the amounts that can be used of these are from 0.05 to 10% by weight, based on the styrene polymer. Similarly, these substances can also be added prior to, during, or after the suspension polymerization reaction to give the EPS of the invention.

To produce the expandable styrene polymers of the invention by the pelletization process, the blowing agent can be incorporated by mixing into the polymer melt. One possible process comprises the following stages: a) melt production, b) mixing, c) cooling, d) transport, and e) pelletizing. Each of these stages may be executed using the apparatus or combinations of apparatus known from plastics processing. Static or dynamic mixers, such as extruders, are suitable for this mixing process. The polymer melt may be taken directly from a polymerization reactor, or produced directly in the mixing extruder, or in a separate melting extruder via melting of polymer pellets. The cooling of the melt may take place in the mixing assemblies or in separate coolers. Examples of pelletizers which may be used are pressurized underwater pelletizers, a pelletizer with rotating knives and cooling via spray-misting of temperature-control liquids, or pelletizers involving atomization. Examples of suitable arrangements of apparatus for carrying out the process are:

a) polymerization reactor—static mixer/cooler—pelletizer
b) polymerization reactor—extruder—pelletizer
c) extruder—static mixer—pelletizer
d) extruder—pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. There is no need for cooling down to the region of the glass transition temperature.

The die plate is heated at least to the temperature of the polystyrene melt comprising blowing agent. It is preferable that the temperature of the die plate is in the range from 20 to 100° C. above the temperature of the polystyrene melt comprising blowing agent. This prevents polymer deposits within the dies and provides problem-free pelletization.

In order to obtain marketable pellet sizes, the diameter (D) of the die holes at the exit from the die should be in the range from 0.2 to 1.5 mm, preferably in the range from 0.3 to 1.2 mm, particularly preferably in the range from 0.3 to 0.8 mm. This permits controlled setting of pellet sizes below 2 mm, in particular in the range from 0.4 to 1.4 mm, even after die swell.

Particular preference is given to a process which comprises the following steps for the production of expandable styrene polymers (EPS) rendered flame-retardant by a halogen-free method:
a) mixing to incorporate an organic blowing agent and from 1 to 25% by weight of the flame retardant system of the invention into the polymer melt by means of static or dynamic mixer at a temperature of at least 150° C.,
b) cooling of the styrene polymer melt comprising blowing agent to a temperature of at least 120° C.,
c) discharge through a die plate with holes, the diameter of which at the exit from the die is at most 1.5 mm, and
d) pelletization of the melt comprising blowing agent directly behind the die plate under water at a pressure in the range from 1 to 20 bar.

Preference is also given to production of the expandable styrene polymers (EPS) via suspension polymerization in aqueous suspension in the presence of the flame retardant system of the invention and of an organic blowing agent.

In the suspension polymerization process, it is preferable to use styrene alone as monomer. However, up to 20% of its weight can have been replaced by other ethylenically unsaturated monomers, such as alkylstyrenes, divinylbenzene, acrylonitrile, 1,1-diphenylethene or α-methylstyrene.

The usual auxiliaries can be added during the suspension polymerization process, examples being peroxide initiators, suspension stabilizers, blowing agents, chain-transfer agents, expansion aids, nucleating agents, and plasticizers. The amounts of flame retardant of the invention added in the polymerization process are from 0.5 to 25% by weight, preferably from 5 to 15% by weight. The amounts of blowing agents added are from 2 to 10% by weight, based on monomer. These amounts can be added prior to, during, or after polymerization of the suspension. Examples of suitable blowing agents are aliphatic hydrocarbons having from 4 to 6 carbon atoms. It is advantageous to use inorganic Pickering dispersants as suspension stabilizers, an example being magnesium pyrophosphate or calcium phosphate.

The suspension polymerization process produces bead-shaped particles which are in essence round, with average diameter in the range from 0.2 to 2 mm.

In order to improve processability, the finished expandable styrene polymer pellets can be coated with glycerol ester, antistatic agent, or anticaking agent.

The EPS pellets can be coated with glycerol monostearate GMS (typically 0.25%), glycerol tristearate (typically 0.25%), Aerosil R972 fine-particle silica (typically 0.12%), or Zn stearate (typically 0.15%), or else antistatic agent.

The expandable styrene polymer pellets can be prefoamed in a first step by means of hot air or steam to give foam beads with density in the range from 5 to 200 kg/m³, in particular from 10 to 50 kg/m³, and can be fused in a second step in a closed mold, to give molded particles.

The expandable polystyrene particles can be processed to give polystyrene foams with densities of from 8 to 200 kg/m³, preferably from 10 to 50 kg/m³. To this end, the expandable beads are prefoamed. This is mostly achieved by heating of the beads, using steam in what are known as prefoamers. The resultant prefoamed beads are then fused to give moldings. To this end, the prefoamed beads are introduced into molds which do not have a gas-tight seal, and are treated with steam. The moldings can be removed after cooling.

In another preferred embodiment, the foam is an extruded polystyrene (XPS), obtainable via:
a) heating of a polymer component P to form a polymer melt,
b) introduction of a blowing agent component T into the polymer melt to form a foamable melt,
c) extrusion of the foamable melt into a region of relatively low pressure with foaming to give an extruded foam, and
d) addition of the flame retardant system of the invention and also, optionally, of further auxiliaries and additives, in at least one of the steps a) and/or b).

Foams of the invention based on styrene polymers, in particular EPS and XPS, are suitable by way of example for use as insulation materials, in particular in the construction industry. Preference is equally given to the use as packaging materials. A preferred use is as halogen-free insulation material, in particular in the construction industry.

The extinguishment time (DIN 4102 B2 fire test for foam density 15 g/l and aging time 72 h) of foams of the invention, in particular those based on styrene polymers, such as EPS and XPS, is preferably ≦15 sec, particularly preferably ≦10 sec, and they thus satisfy the conditions for passing said fire test, as long as the flame height does not exceed the test level stated in the standard.

The examples below provide further explanation of the invention, but with no resultant restriction.

### EXAMPLES

Component a) Di- and polysulfides (I)

| | | |
|---|---|---|
| 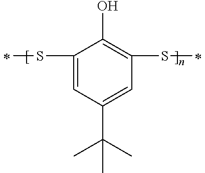 | Poly(tert-butylphenol disulfide) | SC1 |
| 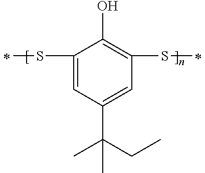 | Poly(tert-amylphenol disulfide) | SC2 |
| 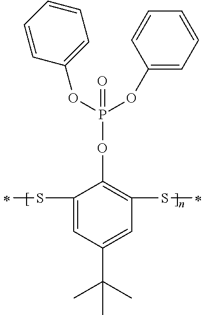 | Phosphated poly(tert-butylphenol disulfide) | SC3 |

Component b) Phosphorus compounds

| | | |
|---|---|---|
| 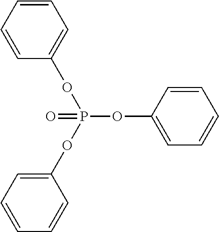 | Triphenyl phosphate | PC1 |
| 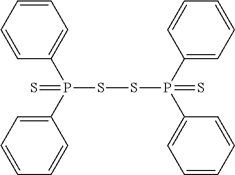 | Bis(diphenylphosphinothioyl) disulfide | PC2 |
| 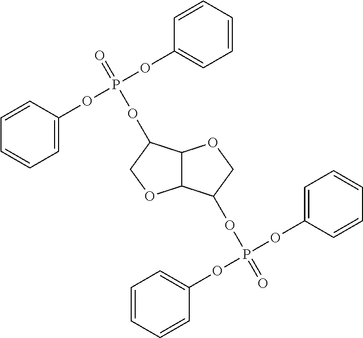 | Diphenyl 6-(diphenoxyphosphoryloxy)hexa- hydrofuro[3,2-b]furan-3-yl phosphate | PC3 |
| 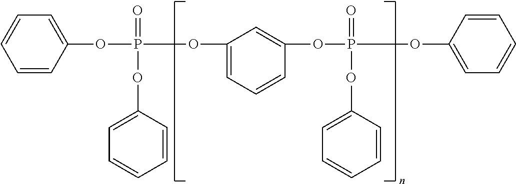 | Poly[resorcinol bis(diphenyl phosphate)] | PC4 |
| 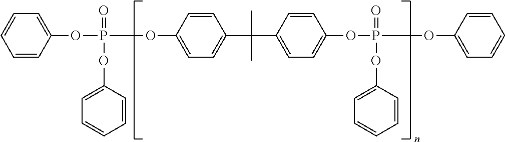 | Poly[bisphenol A bis(diphenyl phosphate)] | PC5 |

The sulfur compounds SC1 and SC2 used in the examples are commercially available compounds from Arkema, marketed as Vultac 2 and, respectively, Vultac 3, and Vultac TB7. The compound SC3 was synthesized in accordance with the synthesis specification given below.

Polyphosphation of poly(tert-butylphenol disulfide) (SC3)

### Apparatus

1000 mL stirred apparatus, argon inertization

### Mixture:

| | | | |
|---|---|---|---|
| 42.6 | g | (0.1 mol) | of poly(tert-butylphenol disulfide) |
| 22.3 | g | (0.22 mol) | of triethylamine |
| 53.7 | g | (0.2 mol) | of diphenyl chlorophosphate |
| 250 | ml | | of methylene chloride |

Poly(tert-butylphenol disulfide) (42.6 g, 0.1 mol) was introduced in methylene chloride (250 mL) and triethylamine (22.3 g, 0.22 mol) at room temperature (RT) in a standard 1 L stirred apparatus. Diphenyl chlorophosphate (53.7 g, 0.2 mol) was added dropwise at from 23 to 31° C. within a period of 30 min, with stirring. An exothermic reaction occurred. Stirring of the mixture continued for 4.5 h at an oil bath temperature of 40° C., and it was then cooled to RT. 2 phases formed here. Monitoring of the dark, clear lower phase via ³¹P NMR indicated quantitative conversion. The reaction mixture was washed with deionized water (3×200 mL), and the resultant organic phase was dried overnight over Na₂SO₄. The Na₂SO₄ was removed by suction filtration and then washed with methylene chloride (1×100 mL). The filtrate was concentrated by evaporation on a rotary evaporator in vacuo (65° C., 77 mbar), and then dried at 60° C. for 4 h under the vacuum provided by an oil pump.

The product obtained was a yellow-brown resin (83.3 g, 99% of theory), purity >98% (based on P NMR).

### Analytical Data:

³¹P NMR (CDCl₃), [ppm]: (−17.4)-(−18.6) multiplet.

The organophosphorus compounds PC 1 to 5 used in the examples were synthesized by known methods or purchased:

### PC1: Disflamoll TP (Lanxess)

### PC2: M. G. Zimin; N. G. Zabirov; V. Smirnov; Zhournal Obschei Khimii; 1980; 50; 1; 24-30.

### PC3:

Synthesis of isosorbide bis(diphenyl phosphate):

### Apparatus:

4000 ml stirred apparatus, argon inertization

### Mixture:

| | | | |
|---|---|---|---|
| 298.2 | g | (2.0 mol) | of 98% isosorbide |
| 506 | g | (5.0 mol) | of triethylamine |
| 2000 | mL | | of toluene |
| 1120 | g | (4.0 mol) | of 96% diphenyl chlorophosphate |

Molten isosorbide (298.2 g, 2 mol) is introduced at RT in toluene (2000 mL) in a standard 4 L stirred apparatus. Much of the isosorbide reprecipitates here. The mixture is heated to 80° C. (90% of the isosorbide has been dissolved). The solution is then allowed to return to RT. Diphenyl chlorophosphate (1120 g, 4.0 mol) is then added dropwise within a period of 5 h at 22 to 42° C. Stirring of the cloudy yellow mixture is continued at RT overnight. Monitoring of the reaction via ³¹P NMR indicates quantitative conversion.

The triethylammonium chloride precipitated is removed by suction filtration by way of a (nitrogen-inertized) Schlenk frit, and then washed with toluene (1×300 mL). The filtrate is subjected to extraction by shaking with saturated aqueous Na₂CO₃ solution (2×500 mL), and then washed with water (2×500 mL) and dried over Na₂SO₄ overnight. The Na₂SO₄ is removed by suction filtration and then washed with toluene (1×300 mL). The filtrate is concentrated by evaporation on a rotary evaporator in vacuo (65° C., 77 mbar), and then dried at 80° C. for 4 h under the vacuum provided by an oil pump.

The product obtained is a red-brown oil (1046 g, 86% of theory), purity >96% (based on ³¹P NMR).

The pH of an aqueous emulsion of the product was 5.0.

### Analytical Data:

³¹P NMR (toluene_{d8}), [ppm]: −11.2 (d, ³J_{P,H}=7 Hz), −11.9 (d, ³J_{P,H}=7 Hz) (2 isomers).

¹H NMR (toluene_{d8}), [ppm]: 7.37-7.22 (m, 8H, ar), 7.16-7.00 (m, 8H, ar), 7.00-6.89 (m, 4H, ar), 5.15-5.01 (m, 1H, CH_{isosorbide}), 4.95-4.82 (m, 1H, CH_{isosorbide}), 4.62-4.52 (m, 1H, CH_{isosorbide}), 4.50-4.40 (m, 1H, CH_{isosorbide}), 4.08-3.96 (m, 1H, CH_{isosorbide}), 3.83-3.71 (m, 1H, CH_{isosorbide}), 3.69-3.59 (m, 1H, CH_{isosorbide})_{,} 3.59-3.47 (m, 1H, CH_{isosorbide}).

### PC4: Fyrolflex® RDP (ICL-IP Europe BV)

### PC5: Fyrolflex® BDP (ICL-IP Europe BV)

### Description of Tests:

The fire performance of the foam sheets was determined using a foam density of 15 kg/m³ to DIN 4102 (fire test B2).

A comparative test was carried out using hexabromocyclododecane (hereinafter termed HBCD).

### Expandable Styrene Polymers (Extrusion Process)

7 parts by weight of n-pentane were incorporated by mixing into a polystyrene melt made of PS 148H (Mw=240 000 g/mol, Mn=87 000 g/mol, determined by means of GPC, RI detector, PS as standard) from BASF SE, with intrinsic viscosity IV of 83 ml/g. Once the melt comprising blowing agent had cooled from initially 260° C. to a temperature of 190° C., a polystyrene melt comprising the flame retardants mentioned in the table was incorporated into the main stream by mixing by way of an ancillary extruder (table 1a).

In some examples, 3.6 parts by weight of graphite were metered into the polymer melt (table 1 b).

The amounts stated in parts by weight are based on the entire amount of polystyrene, 100 parts.

The mixture made of polystyrene melt, blowing agent, and flame retardant was conveyed at 60 kg/h through a die plate with 32 holes (diameter of dies 0.75 mm). Compact pellets with narrow size distribution were produced by pressurized underwater pelletization.

The molar mass of the pellets was 220 000 g/mol (Mw) and, respectively, 80 000 g/mol (Mn) (determined by means of GPC, RI detector, PS as standard).

The pellets were prefoamed by exposure to a stream of steam and, after 12 hours of storage, fused in a closed mold by further treatment with steam to give foam slabs of density 15 kg/m³. The fire performance of the foam sheets was determined after 72 hours of storage with a foam density of 15 kg/m³ to DIN 4102.

Table 1 collates the results:

TABLE 1a
Fire performance of polymer compositions of the invention
(inventive examples) and of comparative examples

| | Flame retardant | | Synergist | Fire test |
|---|---|---|---|---|
| | (pts. by wt., based | | (pts. by wt., based | (B2 to DIN 4102)/ |
| Example | on polystyrene) | | on polystyrene) | extinguishment time (s) |
| CE1 | — | | — | not passed/consumed |
| | | | | by combustion |
| CE2 | HBCD | (4.0) | — | passed/6.4 s |
| 1 | PC1 | (5.0) | SC1 (2.5) | passed/9.7 s |
| 2 | PC2 | (2.5) | SC2 (2.5) | passed/12.1 s |
| 3 | PC3 | (2.5) | SC1 (2.5) | passed/5.6 s |
| 4 | PC3 | (2.5) | SC2 (2.5) | passed/7.6 s |
| 5 | PC2 | (2.5) | SC3 (5.0) | passed/9.1 s |
| 6 | PC4 | (2.5) | SC3 (5.0) | passed/9.5 s |
| 7 | PC4 | (2.5) | SC1 (2.5) | passed/8.6 s |
| 8 | PC4 | (2.5) | SC2 (2.5) | passed/7.2 s |
| 9 | PC1 | (1.0) | SC1 (2.5) | passed/7.5 s |
| 10 | PC1 | (1.0) | SC2 (3.5) | passed/7.1 s |
| 11 | PC3 | (1.0) | SC1 (2.5) | passed/9.3 s |
| 12 | PC3 | (1.0) | SC2 (3.5) | passed/8.6 s |
| 14 | PC4 | (1.0) | SC1 (2.5) | passed/6.5 s |
| 15 | PC4 | (1.0) | SC2 (3.5) | passed/7.8 s |

TABLE 1b
Fire performance of polymer compositions of the invention comprising
3.6 parts by weight of graphite (inventive examples) and of
comparative examples

| | | | Fire test (B2 to |
|---|---|---|---|
| | Flame retardant | Synergist | DIN 4102)/ |
| | (pts. by wt., based | (pts. by wt., based | extinguishment |
| Example | on polystyrene) | on polystyrene) | time (s) |
| CE3 | — | — | not passed/consumed |
| | | | by combustion |
| CE4 | HBCD (4.0) | — | passed/8.1 s |
| 15 | PC1 (1.0) | SC1 (2.5) | passed/5.0 s |
| 16 | PC1 (1.0) | SC2 (3.5) | passed/8.8 s |
| 17 | PC3 (1.0) | SC1 (2.5) | passed/7.9 s |
| 18 | PC3 (0.5) | SC1 (3.5) | passed/8.2 s |
| 19 | PC3 (1.0) | SC2 (3.5) | passed/7.5 s |
| 20 | PC4 (1.0) | SC1 (2.5) | passed/3.8 s |
| 21 | PC4 (1.0) | SC2 (3.5) | passed/4.5 s |
| 22 | PC5 (1.0) | SC1 (3.5) | passed/5.6 s |
| 23 | PC5 (1.0) | SC2 (3.5) | passed/9.2 s |

TABLE 2
Effect of foam density of polystyrene foam test specimens
produced from EPS on fire result

| | Flame retardant | Foam density | Fire test |
|---|---|---|---|
| | (pts. by wt., based | [kg/m³] | (B2 to DIN 4102)/ |
| Example | on polystyrene) | (ISO 845) | extinguishment time (s) |
| 3 | PC3 (2.5) + SC2 (2.5) | 14.8 | passed/5.6 s |
| 24 | PC3 (2.5) + SC2 (2.5) | 25.2 | passed/7.0 s |
| 25 | PC3 (2.5) + SC2 (2.5) | 51.6 | passed/12.1 s |
| 26 | PC3 (2.5) + SC2 (2.5) | 111.8 | passed/14.5 s |

TABLE 3
Effect of flame retardants on the heat resistance of
polystyrene foam test specimens produced from EPS

| | | Heat resistance |
|---|---|---|
| | Flame retardant | (to DIN EN 1604; linear |
| | (pts. by wt., based | dimensional change after |
| Example | on polystyrene) | 48 h, 70° C.) (%) |
| CE1 | — | 0.0 |
| CE2 | HBCD (4.0) | 0.5 |
| 1 | PC1 (5.0) + SC1 (2.5) | 2.1 |
| 2 | PC2 (2.5) + SC2 (2.5) | 1.5 |
| 3 | PC3 (2.5) + SC1 (2.5) | 1.5 |
| 4 | PC3 (2.5) + SC2 (2.5) | 1.7 |
| 7 | PC4 (2.5) + SC1 (2.5) | 1.9 |
| 8 | PC4 (2.5) + SC2 (3.5) | 2.0 |
| 9 | PC1 (1.0) + SC1 (2.5) | 0.7 |
| 10 | PC1 (1.0) + SC2 (3.5) | 0.9 |
| 11 | PC3 (1.0) + SC1 (2.5) | 0.5 |
| 12 | PC3 (1.0) + SC1 (3.5) | 0.6 |
| 13 | PC4 (1.0) + SC1 (2.5) | 0.7 |
| 14 | PC4 (1.0) + SC2 (3.5) | 0.8 |

TABLE 4
Effect of flame retardants on compressive stress for
polystyrene foam test specimens produced from EPS

| | Flame retardant | Compressive stress |
|---|---|---|
| Example | (pts. by wt., based on polystyrene) | (kPa) (to ISO 844) |
| CE2 | HBCD (4.0) | 75.2 |
| 1 | PC1 (5.0) + SC1 (2.5) | 71.6 |
| 3 | PC3 (2.5) + SC2 (2.5) | 73.3 |
| 4 | PC3 (2.5) + SC1 (2.5) | 72.7 |

### Styrene Polymers (Miniextruder Experiments)

Polystyrene 158K was extruded with the respective flame retardancy additives at 180° C. for a period of 5 min in a DSM Micro 15 extruder. The Vicat test specimens were injection molded by using a 10 cc Micro-Injection Molding Machine (DSM).

Table 5 collates the results of the Vicat measurements.

TABLE 5
Effect of flame retardants on the Vicat softening
point of polystyrene test specimens

| | Flame retardant | Vicat softening point |
|---|---|---|
| | (pts. by wt., based | VST/B/50 (° C.) |
| Example | on polystyrene) | (to ISO 306) |
| CE3 | — | 101 |
| CE4 | HBCD (4.0) | 96 |
| 27 | PC3 (2.5) + SC1 (2.5) | 93 |
| 28 | PC3 (1.0) + SC1 (2.5) | 96 |
| 29 | PC3 (1.0) + SC3 (2.5) | 95 |
| 30 | PC4 (1.0) + SC1 (2.5) | 96 |
| 31 | PC5 (1.0) + SC1 (2.5) | 96 |

### Extruded Polystyrene Foam Sheets

100 parts by weight of polystyrene 158K (Mw=261 000 g/mol, Mn=77 000 g/mol, determined by means of GPC, RI detector, PS as standard) from BASF SE with an intrinsic viscosity of 98 ml/g, 0.1 part of talc as nucleating agent to regulate cell size, and the number of parts stated in the table of flame retardants, and also optionally sulfur, are introduced continuously into an extruder with an internal screw diameter of 120 mm. A blowing agent mixture made of 3.25 parts by weight of ethanol and 3.5 parts by weight of CO₂ is continuously and simultaneously injected through an inlet aperture in the extruder. The gel uniformly kneaded at 180° C. in the extruder is conducted through a relaxation zone and, after a residence time of 15 minutes, extruded at a discharge temperature of 105° C. through a die of width 300 mm and height 1.5 mm, into the atmosphere. The foam is conducted through a calibrator connected to the extruder, whereupon the web of foamed sheet produced has a cross section of 650 mm×50 mm and a density of 35 g/l. The molar mass of the polystyrene was 240 000 g/mol (Mw) and, respectively, 70 000 g/mol (Mn) (determined by means of GPC, RI detector, PS as standard). The product was chopped to give sheets. The fire performance of the specimens was tested using thicknesses of 10 mm after 30 days of lying time, to DIN 4102.

Table 6 collates the results of the examples.

TABLE 6
Fire performance of polymer compositions of the invention
(inventive examples) and of comparative examples

| | Flame retardant | | Synergist | Fire test |
|---|---|---|---|---|
| | (% by wt., based | | (% by wt., based | (B2 to DIN 4102)/ |
| Example | on polystyrene) | | on polystyrene) | extinguishment time (s) |
| CE21 | — | | — | not passed/consumed by |
| | | | | combustion |
| CE22 | HBCD | (4.0) | — | passed/7.2 s |
| CE23 | PC3 | (5.0) | — | not passed/consumed by |
| | | | | combustion |
| CE24 | PC4 | (5.0) | — | not passed/consumed by |
| | | | | combustion |
| 32 | PC3 | (2.5) | SC1 (2.5) | passed/5.8 s |
| 33 | PC3 | (2.5) | SC2 (2.5) | passed/7.7 s |
| 34 | PC3 | (1.0) | SC1 (2.5) | passed/6.1 s |
| 35 | PC3 | (1.0) | SC2 (3.5) | passed/5.5 s |
| 36 | PC3 | (0.75) | SC1 (2.5) | passed/6.0 s |
| 37 | PC3 | (0.75) | SC2 (2.5) | passed/8.4 s |
| 38 | PC3 | (0.5) | SC1 (3.5) | passed/3.9 s |
| 39 | PC3 | (0.5) | SC2 (4.0) | passed/7.0 s |
| 40 | PC1 | (1.0) | SC1 (2.5) | passed/5.3 s |
| 41 | PC4 | (1.0) | SC1 (2.5) | passed/4.4 s |
| 42 | PC4 | (1.0) | SC2 (3.5) | passed/6.3 s |
| 43 | PC5 | (1.0) | SC1 (2.5) | passed/8.8 s |
| 44 | PC5 | (1.0) | SC2 (3.5) | passed/9.1 s |

1. A flame retardant system comprising
a) at least one sulfur compound of the formula (I), 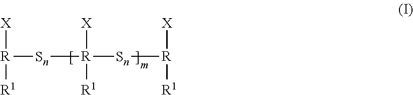
where the definitions of the symbols and indices are as follows:
R, being identical or different, preferably identical, is C₆-C₁₂-aryl, a 5-10-membered heteroaryl group which comprises one or more heteroatoms from the group of N, O, and S, C₁-C₁₈-alkyl, C₂-C₁₈-alkenyl, C₃-C₁₈-alkynyl, or C₃-C₁₀-cycloalkyl;
X, being identical or different, preferably identical, is OR², SR², NR²R³, COOR², CONR², SO₂R², F, Cl, Br, R, H, or a —Y¹—P(Y²)ₚR′R″ group;
Y¹ is O, S, or NR′″;
Y² is O or S;
p is 0 or 1;
R′ and R″, being identical or different, preferably identical, are C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, a heteroaryl group or heteroaryloxy group which comprises one or more heteroatoms from the group of N, O, and S, O—(C₁-C₁₈)-alkyl, O—(C₂-C₁₈)-alkenyl, O—(C₂-C₁₀)-alkynyl, O—(C₆-C₁₂)-aryl, O—(C₃-C₁₀)-cycloalkyl or (C₆-C₁₂)-aryl-(C₁-C₁₈)-alkyl-O;
R′″ is H, C₁-C₁₈-alkyl, or (P(Y²)ₚR′R″);
R¹, being identical or different, preferably identical, is C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, a heteroaryl group which comprises one or more heteroatoms from the group of N, O, and S, O—(C₁-C₁₈)-alkyl, O—(C₂-C₁₈)-alkenyl, O—(C₃-C₁₈)-alkynyl, O—(C₆-C₁₂)-aryl, O—(C₃-C₁₀-cycloalkyl, (C₆-C₁₂)-aryl-(C₁-C₁₈)-alkyl-O, S—(C₁-C₁₈)-alkyl, S—(C₁-C₁₈)-alkenyl, S—(C₂-C₁₈)-alkynyl, S—(C₆-C₁₂)-aryl, S—(C₃-C₁₀)-cycloalkyl, (C₆-C₁₂)-aryl-(C₁-C₁₈)-alkyl-S, OH, F, Cl, Br, or H;
R², R³, being identical or different, preferably identical, are H, C₁-C₁₈-alkyl, C₂-C₁₈-alkenyl, C₂-C₁₈-alkynyl, C₆-C₁₂-aryl, C₃-C₁₀-cycloalkyl, C₆-C₁₂-aryl-C₁-C₁₈-alkyl, or a heteroaryl group which comprises one or more heteroatoms from the group of N, O, and S;
n is an integer from 1 to 8, and
m is a number from 1 to 1000;
b) at least one halogen-free organophosphorus compound with phosphorus content in the range from 0.5 to 40% by weight, based on the phosphorus compound.

2. The flame retardant system according to claim 1, where the definitions of the symbols and indices in the formula (I) are as follows:
R is C₆-C₁₂-aryl or a 5-10-membered heteroaryl group which comprises from one to three heteroatoms from the group of N, O, and S;
X is OR², SR², NR²R³, COOR², CONR²R³, SO₂R², F, Cl, Br, H, or a Y¹—P(Y²)ₚR′R″ group;
Y¹ is O or S;
Y² is O or S;
p is 0 or 1;
R′ and R″, being identical or different, are C₁-C₁₈-alkyl, C₂-C₁₈-alkenyl, C₂-C₂₈-alkynyl, C₃-C₁₀-cycloalkyl, C₆-C₁₂-aryl, C₆-C₁₂-aryl-C₁-C₁₈-alkyl, O—(C₁-C₁₈)-alkyl, O—(C₃-C₁₀)-cycloalkyl, O—(C₆-C₁₂)-aryl, (C₆-C₁₂)-aryl-(C₁-C₁₈)-alkyl-O;
R¹ is C₁-C₁₈-alkyl, C₂-C₁₈-alkenyl, C₃-C₁₈-alkynyl, C₃-C₁₀-cycloalkyl, O—(C₁-C₁₈)-alkyl, O—(C₂-C₁₈)-alkenyl, O—(C₃-C₁₈)-alkynyl, or O—(C₃-C₁₀)-cycloalkyl;
R² and R³, being identical or different, are H, C₁-C₁₈-alkyl, C₂-C₁₈-alkenyl, C₃-C₁₈-alkynyl, C₃-C₁₀-cycloalkyl, C₆-C₁₀-aryl, or C₆-C₁₀-aryl-C₁-C₁₈-alkyl;
n is an integer from 2 to 6, and
m is a number from 2 to 500.

3. The flame retardant system according to claim 1, where the definitions of the symbols in the formula (I) are as follows:
R is C₆-C₁₀-aryl;
X is OR², SR², NR²R³, COOR², COONR²R³, SO₂R², or a Y¹—P(Y²)ₚR′R″ group;
Y¹ is O or S;
Y² is O or S;
p is 0 or 1;
R′ and R″, being identical, are C₁-C₁₈-alkyl, C₆-C₁₂-aryl, O—(C₁-C₁₈)-alkyl, or O—(C₆-C₁₂)-aryl;
R¹ is C₁-C₁₆-alkyl;
R² and R³, being identical, are H, C₁-C₁₈-alkyl or C₆-C₁₂-aryl;
n is from 2 to 4, and
m is a number from 2 to 250.

4. The flame retardant system according to claim 1, where the compound(s) of the formula (I) has/have been selected from poly(tert-butylphenol disulfide), poly(tert-amylphenol disulfide), and poly(tert-butylphenol disulfide) phosphated with diphenyl phosphate groups.

5. The flame retardant system according to claim 1, where the phosphorus compound(s) b) has/have been selected from:
b′) phosphorus compounds of the formula (II),
(X¹)ₛ═PR⁴R⁵R⁶ (II)
where the definitions of the symbols and indices in the formula (II) are as follows:
R⁴ is C₁-C₁₆-alkyl, C₁-C₁₀-hydroxyalkyl, C₂-C₁₆-alkenyl, C₁-C₁₆-alkoxy, C₁-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR¹², COR¹³, COOR¹⁴, CONR¹⁵R¹⁶;
R⁵ is C₁-C₁₆-alkyl, C₁-C₁₀-hydroxyalkyl, C₁-C₁₆-alkenyl, C₁-C₁₆-alkoxy, C₁-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR¹², COR¹³, COOR¹⁴, CONR¹⁵R¹⁶;
R⁶ is H, SH, OH, OR⁸ or a —(Y³)ᵥ—[P(═X²)ᵤR⁹—(Y⁴)ₖ]ₗ—P(═X³)ₜR¹⁰R¹¹ group;
or two groups R⁴, R⁵, or R⁶ form, together with the phosphorus atom bonded thereto, a ring system;
X¹, X², and X³, being identical or different, are mutually independently O or S;
Y³ and Y⁴, being identical or different, are O or S;
R⁷, R⁸, R¹², R¹³, R¹⁴, R¹⁵, and R¹⁶, being identical or different, are C₁-C₁₂-alkyl or C₃-C₈-cycloalkyl which is unsubstituted or which has substitution by one or more C₁-C₄-alkyl groups, or are C₂-C₁₂-alkenyl, C₂-C₁₂-alkynyl, C₆-C₁₀-aryl, C₆-C₁₀-aryl-C₁-C₄-alkyl or hydroxy-C₁-C₁₈-alkyl;
R⁹, R¹⁰, and R¹¹, being identical or different, are mutually independently C₁-C₁₆-alkyl, C₂-C₁₆-alkenyl, C₁-C₁₆-alkoxy, C₁-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR¹², COR¹³, COOR¹⁴, CONR¹⁵R¹⁶;
k and v are 0 or 1 if Y³ and, respectively, Y⁴ is O, and are 1, 2, 3, 4, 5, 6, 7, or 8 if Y² and, respectively, Y⁴ is S, and
I is an integer from 0 to 100;
s, t, and u are mutually independently 0 or 1, and
b″) phosphorus compounds of the formula (III), 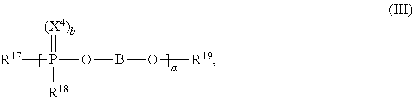
where the definitions of the symbols in the formula (III) are as follows:
B is a 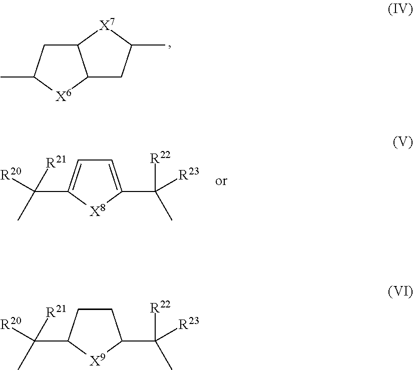
group,
R¹⁹ is —P(═X⁵)_{c}R²⁴R²⁵, H, a straight-chain or branched C₁-C₁₂-alkyl group, C₅-C₆-cycloalkyl, C₆-C₁₂-aryl, or benzyl, where the four last-mentioned groups are unsubstituted or have substitution by one or more radicals from the group of C₁-C₄-alkyl and C₂-C₄-alkenyl;
R¹⁷, R¹⁸, R²⁴, and R²⁵, being identical or different, are hydrogen, OH, C₁-C₁₆-alkyl, C₂-C₁₆-alkenyl, C₁-C₁₆-alkoxy, C₂-C₁₆-alkenoxy, C₃-C₁₀-cycloalkyl, C₃-C₁₀-cycloalkoxy, C₆-C₁₀-aryl, C₆-C₁₀-aryloxy, C₆-C₁₀-aryl-C₁-C₁₆-alkyl, C₆-C₁₀-aryl-C₁-C₁₆-alkoxy, SR²⁶COR²⁷, COOR²⁸, CONR²⁹R³⁰, or two radicals R¹⁷, R¹⁸, R²⁴, or R²⁵ form, together with the phosphorus atom bonded thereto, or together with a P—O—B—O—P group, a ring system;
R²⁰, R²¹, R²², and R²³, being identical or different, are H, C₁-C₁₆-alkyl, C₂-C₁₆-alkenyl, C₁-C₁₆-alkoxy, C₂-C₁₆-alkenoxy;
R²⁶, R²⁷, R²⁸, R²⁹, and R³⁰, being identical or different, are H, C₁-C₁₆-alkyl, C₂-C₁₆-alkenyl, C₆-C₁₀-aryl, C₆-C₁₀-aryl-C₁-C₁₆-alkyl, C₆-C₁₀-aryl-C₁-C₁₆-alkoxy;
X⁴ and X⁵, being identical or different, are S or O;
b and c, being identical or different, preferably identical, are 0 or 1;
X⁶, X⁷, X⁸, and X⁹, being identical or different, are S or O, and
a is a natural number from 1 to 50.

6. The flame retardant system according to claim 1, where one or more phosphorus compounds b) have been selected from oligomeric or polymeric phosphates of the formula (VII), 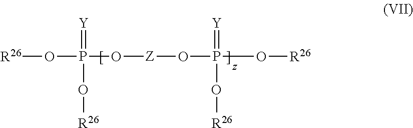
where the definitions of the symbols and indices are as follows:
R²⁶, R²⁷, R²⁸, and R²⁹, being identical or different, are H, linear or branched C₁-C₁₆-alkyl, linear or branched C₂-C₁₆-alkenyl, linear or branched C₂-C₁₆-alkynyl, C₃-C₁₀-cycloalkyl, C₆-C₁₀-aryl, heteroaryl, or C₆-C₁₀-aryl-C₁-C₁₀-alkyl, where aryl in the moieties R²⁶-R²⁸ is respectively mutually independently unsubstituted or has substitution by from 1 to 3 moieties from the group of C₁-C₁₀-alkyl, C₁-C₁₀-alkoxy, C₆-C₁₀-aryl, C₆-C₁₀-aryloxy, OH, CHO, COOH, CN, SH, SCH₃, SO₂CH₃, SO₂—C₆-C₁₀-aryl, SO₃H, COCH₃, COC₂H₅, CO—C₆-C₁₀-aryl, and S—S—C₆-C₁₀-aryl,
or
R²⁶, R²⁷, R²⁸, and R²⁹ are a cationic moiety from the group of the metals and of nitrogen-containing cations,
Z is 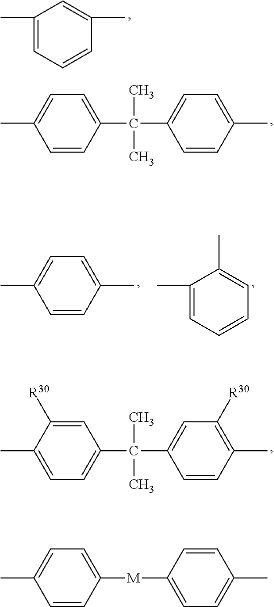
M is —CH₂—, —C(CF₃)₂—, —C(CH₃)(C₆H₅)—, —C(CH₃)(C₂H₅)—, —C(C₆H₅)₂-1,3-phenylene-C(CH₃)₂—, —C(CH₃)₂-1,4-phenylene-C(CH₃)₂—, 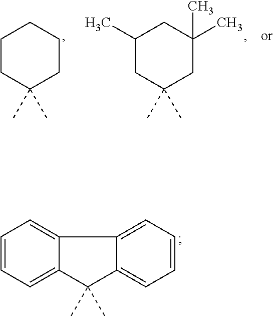
R³⁰ is —CH₃, —CH(CH₃)₂, or C₆H₅, and
n is from 1 to 100;
or from oligomeric or polymeric phosphates of the formula (VIII), 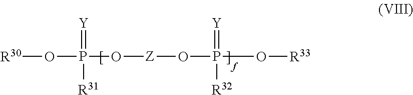
where the definitions of the symbols and indices are as follows:
R³¹, R³², R³³, and R³⁴, being identical or different, are H, linear or branched C₁-C₁₆-alkyl, linear or branched C₂-C₁₆-alkenyl, linear or branched C₂-C₁₆-alkynyl, C₃-C₁₀-cycloalkyl, C₆-C₁₀-aryl, heteroaryl, or C₆-C₁₀-aryl-C₁-C₁₀-alkyl; where aryl in the moieties R³⁰-R³³ is respectively mutually independently unsubstituted or has substitution by from 1 to 3 moieties from the group of C₁-C₁₀-alkyl, C₁-C₁₀-alkoxy, C₆-C₁₀-aryl, C₆-C₁₀-aryloxy, OH, CHO, COOH, CN, SH, SCH₃, SO₂CH₃, SO₂—C₆-C₁₀-aryl, SO₃H, COCH₃, COC₂H₅, CO—C₆-C₁₀-aryl, and S—S—C₆-C₁₀-aryl;
Z is 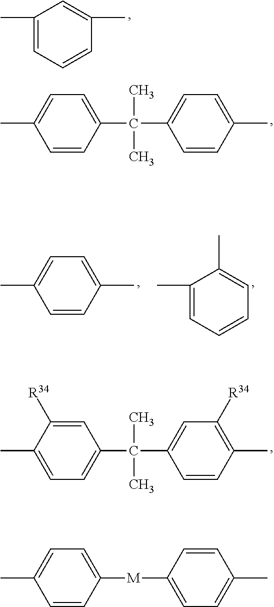
M is —CH₂—, —C(CF₃)₂—, —C(CH₃)(C₆H₅)—, —C(CH₃)(C₂H₅)—, —C(C₆H₅)₂-1,3-phenylene-C(CH₃)₂—, —C(CH₃)₂-1,4-phenylene-C(CH₃)₂—, —O—, —S—, 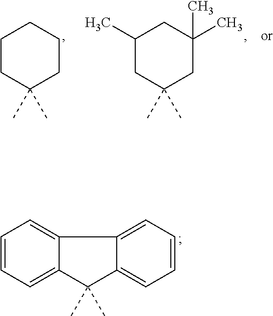
R³⁴ is —CH₃, —CH(CH₃)₂, or C₆H₅, and
f is from 1 to 1000.

7. A process for rendering foamed or unfoamed polymers flame-retardant, where a melt of the polymer, or the monomers from which the polymer is produced, is/are mixed with the flame retardant system according to claim 1.

8. A polymer composition comprising one or more polymers and a flame retardant system according to claim 1.

9. The polymer composition according to claim 8, comprising from 0.1 to 15 parts by weight (based on 100 parts by weight of polymer) of the flame retardant system.

10. The polymer composition according to claim 8, which is halogen-free.

11. The polymer composition according to claim 8, comprising a styrene polymer.

12. The polymer composition according to claim 8, wherein the polymer is a foam.

13. The polymer composition according to claim 12, wherein the density of the polymer foam is from 5 to 150 g/l.

14. The polymer composition according to claim 11, in the form of an expandable styrene polymer (EPS).

15. A process for producing an expandable styrene polymer (EPS) according to claim 14, encompassing the following steps:
a) mixing to incorporate an organic blowing agent and a flame retardant system according to claim 1, and also optionally further auxiliaries and additives, into a styrene polymer melt by means of static and/or dynamic mixers at a temperature of at least 150° C.,
b) cooling of the styrene polymer melt comprising blowing agent to a temperature of at least 120° C.,
c) discharge via a die plate with holes of which the diameter at the exit from the die is at most 1.5 mm, and
d) pelletizing of the melt comprising blowing agent directly behind the die plate under water at a pressure in the range from 1 to 20 bar.

16. A process for producing an expandable styrene polymer according to claim 14, encompassing the following steps:
a) polymerizing one or more styrene monomers in suspension;
b) adding a flame retardant system according to claim 1, and also optionally further auxiliaries and additives prior to, during, and/or after the polymerization reaction;
c) adding an organic blowing agent prior to, during, and/or after the polymerization reaction, and
d) isolating the expandable styrene polymer particles comprising a flame retardant system according to any one of claims 1 to 6 from the suspension.

17. The polymer composition according to claim 11 in the form of an extruded styrene polymer foam (XPS).

18. The polymer composition according to claim 11, comprising as additional component one or more IR absorbers.

19. The polymer composition according to claim 17, comprising as additional component one or more IR absorbers.

20. A process for producing an extruded styrene foam (XPS) according to claim 17, encompassing the following steps:
a) heating a polymer component P which comprises at least one styrene polymer, to form a polymer melt,
b) introducing a blowing agent component T into the polymer melt to form a foamable melt,
c) extruding the foamable melt into a region of relatively low pressure, with foaming to give an extruded foam, and
d) adding a flame retardant system according to claim 1, and also optionally further auxiliaries and additives in at least one of the steps a) and b).

21. The process according to claim 15, where one or more IR absorbers are added as additive.

22. The process according to claim 20, where one or more IR absorbers are added as additive.

23. An insulation material comprising a halogen-free polymer composition according to claim 14.

24. An insulation material comprising a halogen-free polymer composition according to claim 17 in expanded form.
